(19) United States
(12) Patent Application Publication
(10) Pub. No.: US 2025/0240438 A1
(43) Pub. Date: Jul. 24, 2025

(54) LOCAL ILLUMINATION COMPENSATION USING INHERITED MODEL PARAMETER FROM NEIGHBORING BLOCKS

(71) Applicant: QUALCOMM Incorporated, San Diego, CA (US)

(72) Inventors: Chun-Chi Chen, San Diego, CA (US); Han Huang, San Diego, CA (US); Yan Zhang, San Diego, CA (US); Zhi Zhang, Munich (DE); Vadim Seregin, San Diego, CA (US); Marta Karczewicz, San Diego, CA (US)

(21) Appl. No.: 18/986,046

(22) Filed: Dec. 18, 2024

Related U.S. Application Data
(60) Provisional application No. 63/619,626, filed on Jan. 10, 2024.

(51) Int. Cl. H04N 19/196; H04N 19/107; H04N 19/14; H04N 19/176

(52) U.S. Cl. CPC H04N 19/196; H04N 19/107; H04N 19/14; H04N 19/176

(57) ABSTRACT

An example device includes memory, and one or more processors configured to determine to decode a current block of the video data using motion information of a second block of the video data. The one or more processors are configured to determine a value of a LIC flag of the second block, the value of the LIC flag of the second block indicative of LIC being applied to the second block. The one or more processors are configured to determine, based on the value of the LIC flag, to apply LIC to the current block. The one or more processors are configured to infer LIC model parameters of the current block to be equal to LIC model parameters of the second block. The one or more processors are configured to decode the current block including using the inferred LIC model parameters and the motion information of the second block.

This application claims the benefit of U.S. Provisional Patent Application 63/619,626, filed Jan. 10, 2024, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques related to the manner in which a video coder may infer/inherit Local Illumination Compensation (LIC) model parameters for certain blocks, such as inter prediction blocks, intra block copy (IBC) blocks, and intra template matching (IntraTMP) blocks, from coded blocks in a causal neighborhood relative to the currently coded block (e.g., neighboring blocks that have already been reconstructed/decoded).

Merge mode operates under an assumption that a current block shares the same motion characteristics as a neighboring block, but cannot be efficiently partitioned in a frame due to the limitation of the rigid partitioning structure in the frame or picture. Thus, when a merge mode is used for a coding block, the coding block should have the same motion information, including the LIC model parameters and LIC flag, as the neighboring block from where motion information is inferred. However, in many implementations and standards, while the LIC flag is inferred, the LIC model parameters of the current block are re-derived. This re-derivation potentially introduces a negative impact on coding performance and complexity. For example, because LIC model parameters for a current block in merge mode are re-derived, rather than inferred or inherited, a video encoder and/or video decoder may be more complex than necessary and such re-derivation may cause latency and/or video quality issues.

In one example, a method includes: determining to decode a current block of the video data using motion information of a second block of the video data; determining a value of a local illumination compensation (LIC) flag or a non-local illumination compensation (NLIC) flag of the second block, the value of the LIC flag or the NLIC flag of the second block indicative of LIC or NLIC being applied to the second block; determining, based on the value of the LIC flag or the NLIC flag, to apply LIC or NLIC to the current block; inferring LIC model parameters or NLIC model parameters of the current block to be equal to LIC model parameters or NLIC model parameters of the second block; and decoding the current block including using the inferred LIC model parameters or the inferred NLIC model parameters and the motion information of the second block.

In another example, a method includes: encoding a second block of the video data including applying local illumination compensation (LIC) or non-local illumination compensation (NLIC) using a plurality of LIC model parameters or a plurality of NLIC model parameters; signaling a LIC flag or an NLIC flag, a value of the LIC flag or the NLIC flag being indicative of LIC or NLIC being applied to the second block; determining to encode a current block of the video data using motion information of the second block; and encoding the current block using the motion information of the second block and the plurality of LIC parameters or the plurality of NLIC parameters.

In another example, a device includes: one or more memories configured to store the video data; and one or more processors operatively coupled to the one or more memories, the one or more processors configured to: determine to decode a current block of the video data using motion information of a second block of the video data; determine a value of a local illumination compensation (LIC) flag or a non-local illumination compensation (NLIC) flag of the second block, the value of the LIC flag or the NLIC flag of the second block indicative of LIC or NLIC being applied to the second block; determine, based on the value of the LIC flag of the NLIC flag, to apply LIC or NLIC to the current block; infer LIC model parameters or NLIC model parameters of the current block to be equal to LIC model parameters or NLIC model parameters of the second block; and decode the current block including using the inferred LIC model parameters or the inferred NLIC model parameters and the motion information of the second block.

In another example, a device includes: one or more memories configured to store the video data; and one or more processors operatively coupled to the one or more memories, the one or more processors configured to: encode a second block of the video data including applying local illumination compensation (LIC) or non-local illumination compensation (NLIC) using a plurality of LIC parameters or a plurality of NLIC parameters; signal a LIC flag or an NLIC flag, a value of the LIC flag or the NLIC flag being indicative of LIC or NLIC being applied to the second block; determine to encode a current block of the video data using motion information of the second block; and encode the current block using the motion information of the second block and the plurality of LIC parameters or the plurality of NLIC parameters.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2A is a conceptual diagram illustrating example spatial motion vector candidates for merge mode.

FIG. 2B is a conceptual diagram illustrating example spatial motion vector candidates for AMVP mode.

FIG. 3A is a conceptual diagram illustrating an example of a temporal motion vector predictor.

FIG. 3B is a conceptual diagram illustrating an example of motion vector scaling.

FIG. 4 is a conceptual diagram illustrating example geometric partitions.

FIG. 5 is a table illustrating an example of how a split mode index is mapped to a geometric partition angle and offset.

FIG. 6 is a table illustrating an example of a merge index for a geometric partition mode.

FIG. 7 is a conceptual diagram illustrating an example of an edge on templates.

FIG. 8 is a conceptual diagram illustrating an example of geometric partitioning mode blending.

FIG. 9 is a table illustrating example templates for geometric partitions.

FIG. 10 is a conceptual diagram illustrating an example of template matching.

FIG. 11 is a conceptual diagram illustrating an example of sub-block based template matching.

FIG. 12 is a flowchart illustrating example LIC inheritance techniques according to one or more aspects of this disclosure.

FIG. 13 is a flowchart illustrating additional example LIC inheritance techniques according to one or more aspects of this disclosure.

FIG. 14 is a block diagram illustrating an example video encoder that may perform the techniques of this disclosure.

FIG. 15 is a block diagram illustrating an example video decoder that may perform the techniques of this disclosure.

FIG. 16 is a flowchart illustrating an example method for encoding a current block in accordance with the techniques of this disclosure.

FIG. 17 is a flowchart illustrating an example method for decoding a current block in accordance with the techniques of this disclosure.

### DETAILED DESCRIPTION

Merge mode functions under an assumption that a current block shares the same motion characteristics as a neighboring block, but cannot be efficiently partitioned in a frame due to the limitation of the rigid partitioning structure in the frame or picture. Thus, when a merge mode is used for a coding block, the coding block should have the same motion information, including the LIC model parameters and LIC flag, as the neighboring block from where motion information is inferred. However, in many implementations and standards, the LIC flag is the only LIC information that is actually inferred and the LIC model parameters of the current block are re-derived. This re-derivation potentially introduces a negative impact on coding performance and complexity. For example, because LIC model parameters for a current block in merge mode are re-derived, rather than inferred or inherited, a video encoder and/or video decoder may be more complex than necessary and such re-derivation may cause latency and/or video quality issues. By addressing the inferring or inheriting of LIC parameters from another block for a current block, the techniques of this disclosure may therefore improve decoding latency, improve video quality, and/or reduce coder complexity.

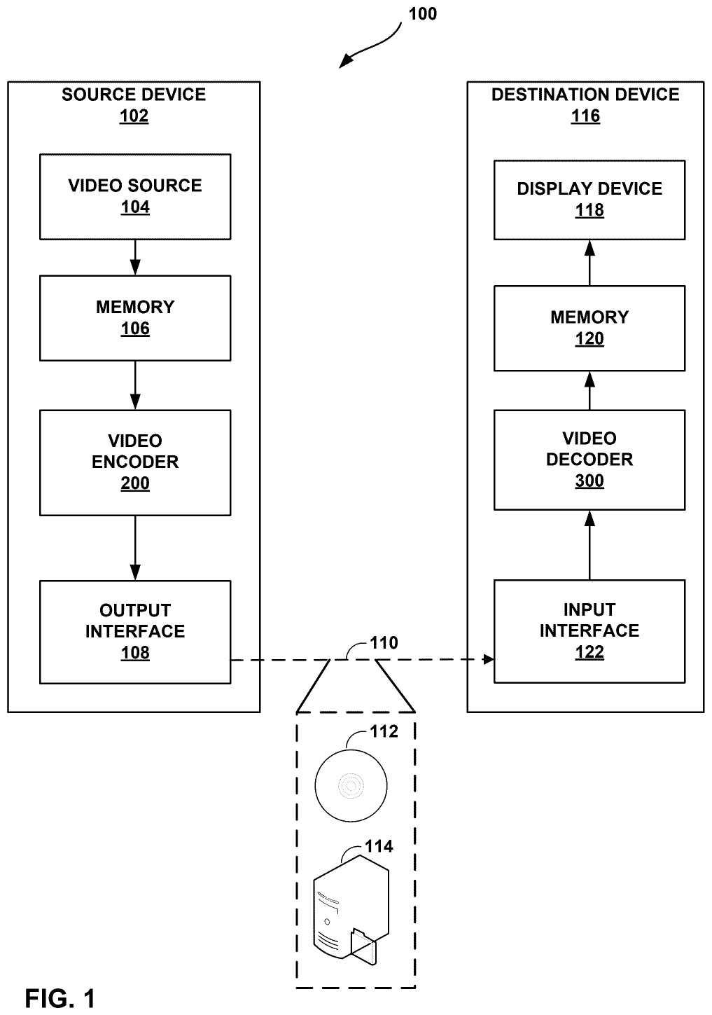

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for LIC. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for LIC. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use LIC.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where Mis not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure describes techniques related to the manner in which a video coder may infer/inherit LIC model parameters for certain blocks, such as inter prediction blocks, IBC blocks, and IntraTMP blocks, from coded blocks in a causal neighborhood relative to the currently coded block (e.g., neighboring blocks that have already been reconstructed/decoded). In accordance with the techniques of this disclosure, video decoder 300 may be configured to determine to decode a current block of the video data using motion information of a second block of the video data; determine a value of a LIC flag or an NLIC flag of the second block, the value of the LIC flag or the NLIC flag of the second block indicative of LIC or NLIC being applied to the second block; determine, based on the value of the LIC flag or the NLIC flag, to apply LIC or NLIC to the current block; infer LIC model parameters or NLIC model parameters of the current block to be equal to LIC model parameters or NLIC model parameters of the second block; and decode the current block including using the inferred LIC model parameters or the inferred NLIC model parameters and the motion information of the second block. In accordance with the techniques of this disclosure, video encoder 200 may be configured to encode a second block of the video data including applying LIC or NLIC using a plurality of LIC parameters or a plurality of NLIC parameters; signal a LIC flag or an NLIC flag, a value of the LIC flag or the NLIC flag being indicative of LIC or NLIC being applied to the second block; determine to encode a current block of the video data using motion information of a second block of the video data; and encode the current block using the motion information of the second block and the plurality of LIC parameters or the plurality of NLIC parameters.

The disclosed techniques herein can be applied to any of the existing video codecs, such as HEVC (High Efficiency Video Coding), VVC (Versatile Video Coding), Essential Video Coding (EVC), or be an efficient coding tool in future video coding standards (e.g., ECM or Enhanced Compression Model).

In the next sections, HEVC, Joint Exploratory Model (JEM) techniques, and works in VVC and ECM related to this disclosure are reviewed.

CU structure and motion vector prediction in HEVC are now described. In HEVC, the largest coding unit in a slice is called a coding tree block (CTB) or coding tree unit (CTU). A CTB contains a quad-tree the nodes of which are coding units. The size of a CTB can range from 16×16 to 64×64 in the HEVC main profile (although technically 8×8 CTB sizes can be supported). A coding unit (CU) could be the same size of a CTB to as small as 8×8. Each coding unit is coded with one mode, e.g., inter or intra. When a CU is inter coded, the CU may be further partitioned into 2 or 4 prediction units (PUs) or become just one PU when further partitions do not apply. When two PUs are present in one CU, the two PUs may be half size rectangles or two rectangles with sizes ¼ or ¾ size of the CU. When the CU is inter coded, each PU has one set of motion information, which is derived with a unique inter prediction mode.

Motion vector prediction is now described. In the HEVC standard, there are two inter prediction modes, named merge (skip is considered as a special case of merge) and advanced motion vector prediction (AMVP) modes respectively for a PU.

In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 or L0 and list 1 or L1) and the reference indices. For example, with bi-prediction, video encoder 200 or video decoder 300 may predict a block using two reference pictures, each associated with its own reference picture list. If a merge candidate is identified by a merge index, the reference pictures used for the prediction of the current blocks, as well as the associated motion vectors are determined. On the other hand, under AMVP mode for each potential prediction direction from either list 0 or list 1, a reference index needs to be explicitly signaled, together with an MV predictor (MVP) index to the MV candidate list, since the AMVP candidate contains only a motion vector. In AMVP mode, the predicted motion vectors can be further refined.

The candidates for both modes are derived similarly from the same spatial and temporal neighboring blocks.

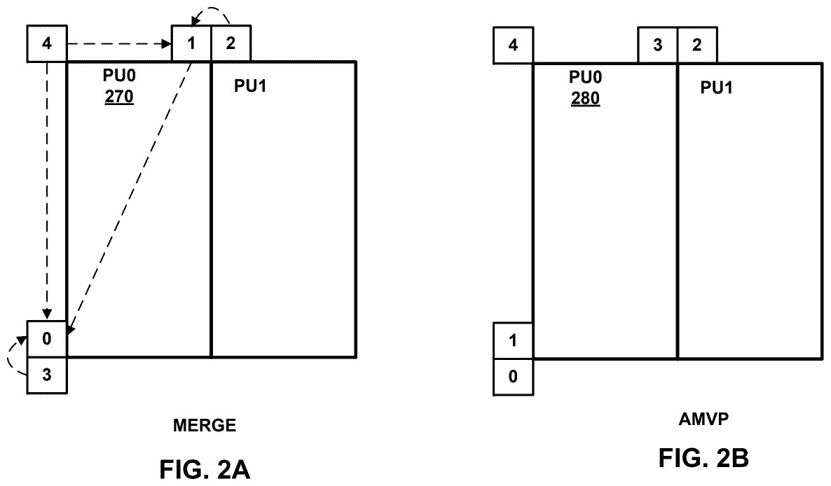

Spatial neighboring candidates are now described. Spatial MV candidates are derived from the neighboring blocks, shown in FIGS. 2A and 2B, for a specific PU (PUo), although the methods for generating the candidates from the blocks differ for merge and AMVP modes.

FIG. 2A is a conceptual diagram illustrating example spatial motion vector candidates for merge mode. In merge mode, for current PUO 270, up to four spatial MV candidates can be derived with the orders showed in FIG. 2A with numbers, and the order is the following: left (0, A1), above (1, B1), above right (2, B0), below left (3, A0), and above left (4, B2).

FIG. 2B is a conceptual diagram illustrating example spatial motion vector candidates for AMVP mode. In AVMP mode, the neighboring blocks of current PUO 280 are divided into two groups: left group consisting of the block 0 and 1, and above group consisting of the blocks 2, 3, and 4 as shown in FIG. 2B. For each group, the potential candidate in a neighboring block referring to the same reference picture as that indicated by the signaled reference index has the highest priority to be chosen to form a final candidate of the group. It is possible that all neighboring blocks do not contain a motion vector pointing to the same reference picture. Therefore, if such a candidate cannot be found, the first available candidate may be scaled to form the final candidate, thus the temporal distance differences can be compensated.

Temporal motion vector prediction in HEVC is now discussed. A temporal motion vector predictor (TMVP) candidate, if enabled and available, may be added into the MV candidate list after spatial motion vector candidates. For example, video encoder 200 or video decoder 300 may add a TMVP to the MV candidate list. The process of motion vector derivation for a TMVP candidate is the same for both merge and AMVP modes. However, the target reference index for the TMVP candidate in the merge mode may always be set to 0.

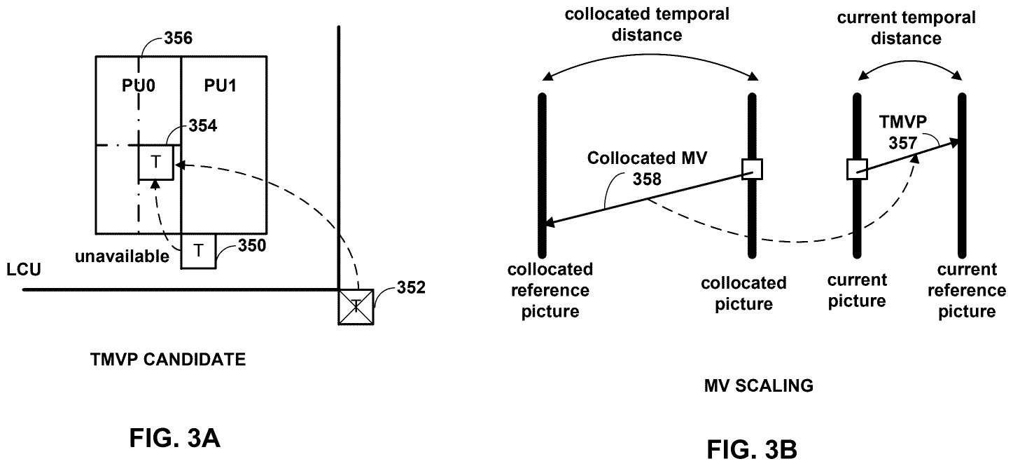

FIG. 3A is a conceptual diagram illustrating an example of a temporal motion vector predictor. FIG. 3A shows example TMVP candidates for block 356 (PUO) and FIG. 3B shows a motion vector scaling process. The primary block location for TMVP candidate derivation is the bottom right block outside of the collocated PU. This candidate is shown in FIG. 3A as a block “T” 354. The location of block T 354 is used to compensate the bias to the above and left blocks used to generate spatial neighboring candidates. However, if that block is located outside of the current CTB row (shown as block T 352), or motion information is not available (shown as block T 350), the block is substituted with a center block of the PU.

FIG. 3B is a conceptual diagram illustrating an example of motion vector scaling. Similar to temporal direct mode in AVC, to derive the TMVP candidate motion vector, the co-located MV may be scaled to compensate the temporal distance differences, as shown in FIG. 3B. Video encoder 200 and video decoder 300 may derive a motion vector for the TMVP candidate from the co-located PU of the co-located picture, indicated in the slice level. The motion vector for the co-located PU is called a collocated MV. Similar to temporal direct mode in AVC, to derive TMVP candidate motion vector 357, co-located MV 358 may be scaled to compensate the temporal distance differences, as shown in FIG. 3B.

Other aspects of motion prediction in HEVC are now described. Several aspects of merge and AMVP modes are described below. Video encoder 200 or video decoder 300 may implement any of, or any combination of, these aspects.

Motion vector scaling: It is assumed that the value of motion vectors is proportional to the distance of pictures in the presentation time. A motion vector associates two pictures, the reference picture, and the picture containing the motion vector (namely the containing picture). When a motion vector is utilized to predict another motion vector, the distance of the containing picture and the reference picture is calculated based on the Picture Order Count (POC) values.

For a motion vector to be predicted, both the motion vector's associated containing picture and reference picture may be different. Therefore, a new distance (based on POC) may be calculated. The motion vector is scaled based on these two POC distances. For a spatial neighboring candidate, the containing pictures for the two motion vectors are the same, while the reference pictures may be different. In HEVC, motion vector scaling applies to both TMVP and AMVP for spatial and temporal neighboring candidates.

Artificial motion vector candidate generation: If a motion vector candidate list is not complete, artificial motion vector candidates may be generated and inserted at the end of the list until the list has all or enough candidates.

In merge mode, there are two types of artificial MV candidates: combined candidates derived only for B-slices and zero candidates used only for AMVP if the first type does not provide enough artificial candidates.

For each pair of candidates that are already in the candidate list and have the necessary motion information, bi-directional combined motion vector candidates are derived by a combination of the motion vector of the first candidate referring to a picture in the list 0 and the motion vector of a second candidate referring to a picture in the list 1.

Pruning process for candidate insertion: Candidates from different blocks may happen to be the same, which decreases the efficiency of a merge/AMVP candidate list. A pruning process is applied to address this problem. The pruning process may compare one candidate against the others in the current candidate list to avoid inserting identical candidates, to a certain extent. To reduce the complexity, only a limited number of pruning processes may be applied instead of comparing each potential candidate with all the other existing candidates.

Reference picture resampling is now described. Video encoder 200 or video decoder 300 may use reference picture resampling techniques described herein. In HEVC, the spatial resolution of pictures cannot change unless a new sequence using a new SPS starts, with an intra random access point (IRAP) picture. VVC enables picture resolution change within a sequence at a position without encoding an IRAP picture, which is always intra-coded. This feature is sometimes referred to as reference picture resampling (RPR), as the feature needs resampling of a reference picture used for inter prediction when that reference picture has a different resolution than the current picture that is being decoded. In order to avoid additional processing steps, the RPR process in VVC is designed to be embedded in the motion compensation process and performed at the block level. In the motion compensation stage, the scaling ratio is used together with motion information to locate the reference samples in the reference picture to be used in the interpolation process.

In VVC, the scaling ratio is restricted to being larger than or equal to 1/2 (2 times down-sampling from the reference picture to the current picture), and less than or equal to 8 (8 times up-sampling). Three sets of resampling filters with different frequency cutoffs are specified to handle various scaling ratios between a reference picture and the current picture. The three sets of resampling filters are applied respectively for the scaling ratio ranging from 1/2 to 1/1.75, from 1/1.75 to 1/1.25, and from 1/1.25 to 8. Each set of resampling filters has 16 phases for luma and 32 phases for chroma which is same to the case of motion compensation interpolation filters. The filter set of normal motion compensation (MC) interpolation may be used in the case of scaling ratio ranging from 1/1.25 to 8. The normal MC interpolation process is a special case of the resampling process with scaling ratio ranging from 1/1.25 to 8. In addition to conventional translational block motion, the affine mode has three sets of 6-tap interpolation filters that are used for the luma component to cover the different scaling ratios in RPR. The horizontal and vertical scaling ratios are derived based on picture width and height, and the left, right, top and bottom scaling offsets specified for the reference picture and the current picture.

For support of this feature, the picture resolution and the corresponding conformance window are signaled in the PPS instead of in the SPS, while in the SPS the maximum picture resolution is signaled.

LIC is now described. Video encoder 200 or video decoder 300 may implement LIC. LIC is an inter prediction technique to model the local illumination variation between a current block and its prediction block as a function of that between a current block template and reference block template. The parameters of the function can be denoted by a scale α and an offset β, which forms a linear equation, that is, α*p [x]+β to compensate illumination changes, where p[x] is a reference sample pointed to by a MV at a location x on the reference picture. When wrap around motion compensation is enabled, the MV may be clipped with a wrap-around offset taken into consideration. Since α and β can be derived based on current block template and reference block template, no signaling overhead is required for them, except that an LIC flag is signaled for AMVP mode to indicate the use of LIC. For the merge mode, the LIC flag is not inherited from a merge candidate. Instead, the LIC flag is derived on-the-fly. More specifically, a merge candidate is derived by comparing two template costs: a SAD-based template cost, denoted as C0, and a Mean Removal SAD (MRSAD)-based template cost, denoted as C1. The LIC flag is set to be false, if C0<=C1 and is set to be true, if C0>C1. To favor the inherited LIC flag, C0 is multiplied by α if the inherited LIC flag is false while C1 is multiplied by α if the inherited LIC flag is true, where α<1.

The LIC proposed in V. Seregin, et. al. “CE4-3.1a and CE4-3.1b: Unidirectional local illumination compensation with affine prediction,” Joint Video Experts Team (JVET) of ITU-T SG 16 WP 3 and ISO/IEC JTC 1/SC 29/WG 11 15^{th} Meeting: Gothenburg, SE, 3-12 Jul. 2019 (hereinafter, JVET-O0066) is used for inter CUs with the following modifications:
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to a first top-left 16×16 unit;
Samples of the reference block template are generated by using MC with the block MV without rounding the block MV to integer-pel precision.

For the bi-predictive inter CUs, two sets of LIC parameters may be separately derived for L0 and L1 prediction samples, respectively. For example, video encoder 200 or video decoder 300 may derive the LIC parameters for L0 prediction samples and for L1 predication samples. An iterative manner to derive the L0 and L1 LIC parameters may be applied. Specifically, L0 LIC parameters may first be derived by minimizing a difference between an L0 template prediction T₀ and the template T and may update the samples in T by subtracting the corresponding samples in T₀. Then, the L1 parameters may be calculated so as to minimize the difference between an L1 template prediction T₁ and the updated template. Finally, the L0 parameters may be refined again in the same way.

In regular and affine merge modes, the LIC flag at a CU level may be inferred from the same neighboring CU from which motion information is inferred. When the inferred LIC flag is true, the model parameters of LIC may be derived based on the aforementioned process.

Non-local illumination compensation (NLIC) is now described. Video encoder 200 or video decoder 300 may implement NLIC.

Firstly, with NLIC, instead of using the template samples, the samples of the previously coded CUs may be utilized for deriving the linear model used for the motion compensation of the current block. Specifically, after the reconstruction of each inter CU (except for geometric partition mode (GPM) and subblock temporal motion vector prediction (SbTMVP) CUs), one linear model may be derived by minimizing the difference between the reconstruction and prediction samples of the block. Then, for both regular and subblock merge modes, up to 6 NLIC candidates, which may be obtained from spatial adjacent and non-adjacent neighbors to the current CU, may be inserted and reordered together with the existing candidates in the merge list. The first N candidates with the smallest SADs may remain in the list, with one index being signaled to indicate which candidate is selected. In JVET-00066, N is kept the same as ECM-10.0, i.e., 10 for regular merge mode and 15 for subblock merge mode. Additionally, the same pattern used for obtaining spatial non-adjacent neighbors in regular merge is reused to locate the corresponding non-adjacent NLIC candidates. When one NLIC candidate is selected, the associated linear model is used together with its motion information (e.g., MVs, CPMVs, reference picture indices and so forth) to generate the prediction samples of the CU.

Geometric partition mode (GEO or GPM) is now described. Video encoder 200 or video decoder 300 may implement GEO or GPM.

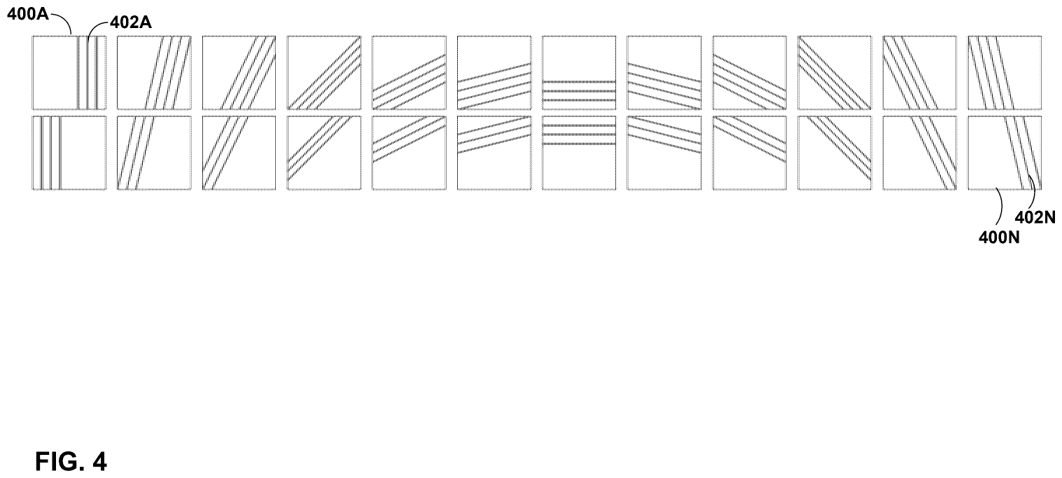

FIG. 4 is a conceptual diagram illustrating example geometric partitions. In VVC, GPM is supported for inter prediction. When this mode is used, a CU is split into two parts by a geometrically located straight line shown in FIG. 4. For example, video encoder 200 or video decoder 300 may split a CU in GPM mode using any of the splits 400A-400N.

For instance, FIG. 4 illustrates split mode 400A to 400N. Each of split modes 400A-400N define an edge (e.g., straight line) that partitions a current block. For instance, FIG. 4 illustrates edge 402A, also called straight line 402A for split mode 400A, and edge 402N, also called straight line 402N for split mode 400N. Edge 402A of split mode 400A is one example way to partition a current block into two partitions, and similarly edge 402N of split mode 400B is another example way to partition a current block into two partitions.

In the example of FIG. 4, there are two lines that are parallel to edge 402A and two lines that are parallel to edge 402N, as well as the other edges. In one or more examples, the two lines that are parallel to respective edges form the area where samples from reference blocks are blended together (e.g., average weighted) to form the prediction block. For instance, for each partition, there may be a motion vector that identifies a reference block. If there are two partitions, then there may be two reference blocks. To generate a prediction block, video encoder 200 and video decoder 300 may utilize samples from the two reference blocks, and for generating samples of the prediction block that correspond to locations within the two lines that are parallel to an edge, video encoder 200 and video decoder 300 may blend samples from the two reference blocks. For samples of the prediction block that correspond to locations outside of the two lines that are parallel to an edge, video encoder 200 and video decoder 300 may utilize samples of one of the two reference blocks to form the prediction block.

In one or more examples, video encoder 200 may determine a motion vector for each of the two partitions (e.g., first motion vector for first partition and second motion vector for second partition). Video encoder 200 may signal information indicative of the motion vectors that video decoder 300 receives. Video encoder 200 and video decoder 300 may determine a first reference block based on the first motion vector and a second reference block based on the second motion vector, and combine samples from the first reference block and the second reference blocks to generate a prediction block for the current block.

To combine samples from the first reference block and the second reference block, video encoder 200 and video decoder 300 may perform a weighted blending. For instance, assume that split mode 400A is being used. For samples relatively distant from edge 402A, video encoder 200 and video decoder 300 may use corresponding samples from one of the first or second reference blocks, without blending, to generate a corresponding prediction sample in the prediction block. For samples relatively close to edge 402A, video encoder 200 and video decoder 300 may use weighted average samples from the first and second reference blocks to generate a corresponding prediction sample in the prediction block. The area that is “relatively close” to edge 402A may be defined by the area between two lines parallel to edge 402A. Video encoder 200 and video decoder 300 may perform similar operations to generate a prediction block for the other split mode examples.

The location of the splitting line is mathematically derived from the angle and offset parameters of a specific partition. In VVC, there are 64 splitting modes. The splitting modes are organized in order by angles (from smaller one to larger on) firstly and offsets (from smaller one to larger one) secondly, and each setting of angle-offset is assigned with an index (i.e., 0 to 63) that is binarized using fixed-length code with each bin bypass-coded. The fixed-length code is a full-tree structure with 6 bins at each tree leave node.

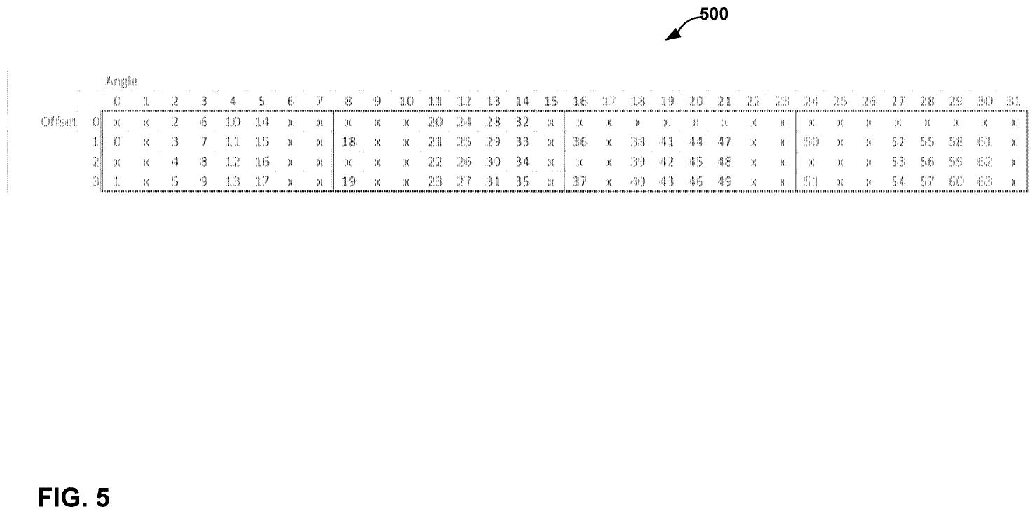

FIG. 5 is a table illustrating an example of how a split mode index is mapped to a geometric partition angle and offset. The table 500 in FIG. 5 shows how a split mode index is mapped to angle-offset, where the N-th angle mode (i.e., N=0, . . . , 7 or 16, . . . , 23) has an edge that is perpendicular to that of (N+8)-th angle mode. Each part of a geometric partition in the CU is inter-predicted using its own motion; only uni-prediction is allowed for each partition, that is, each part has one motion vector and one reference index.

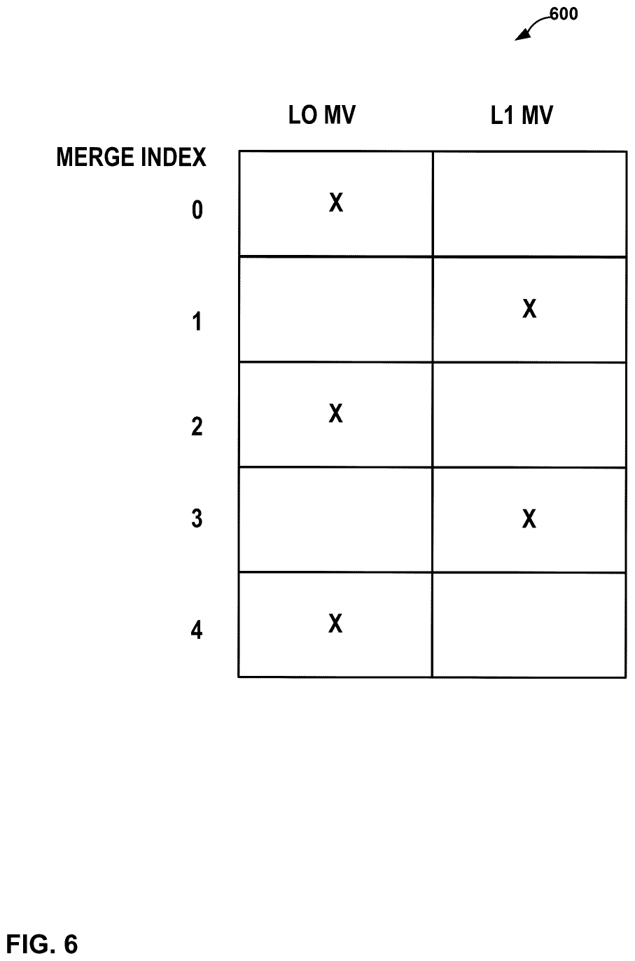

FIG. 6 is a table illustrating an example of a merge index for a geometric partition mode. The uni-prediction candidate list for GEO mode may be derived directly from the regular merge candidate list. For example, n may be the index of the uni-prediction motion in the geometric uni-prediction candidate list. As shown in table 600 of FIG. 6, the LX motion vector of the n-th merge candidate, with X equal to the parity (even or odd) of n, is used as the n-th uni-prediction motion vector for geometric partitioning mode. These motion vectors are marked with “X” in FIG. 6. In case a corresponding LX motion vector of the n-the extended merge candidate does not exist, the L(1−X) motion vector of the same candidate is used instead as the uni-prediction motion vector for geometric partitioning mode.

As specified in B. Bross, et. al. “Versatile Video Coding Editorial Refinements on Draft 10,” Joint Video Experts Team (JVET) of ITU-T SG 16 WP 3 and ISO/IEC JTC 1/SC 29/WG 11 20^{th} Meeting: by teleconference, 7-16 Oct. 2020 (hereinafter, JVET-T2001), the derivation process of GEO weights is specified in the subclause 8.5.7.2 (Weighted sample prediction process for geometric partitioning mode) Inputs to this derivation process are:
two variables nCbW and nCbH specifying the width and the height of the current coding block,
two (nCbW)×(nCbH) arrays predSamplesLA and predSamplesLB,
a variable angleIdx specifying the angle index of the geometric partition,
a variable distanceIdx specifying the distance index of the geometric partition,
a variable cIdx specifying colour component index.

The output of this derivation process is the (nCbW)x(nCbH) array pbSamples of prediction sample values.

The variables nW, nH, shift1, offset1, displacementX, displacementY, partFlip and shiftHor are derived as follows:

$$nW = ( cIdx == 0 ) ? nCbW : nCbW * SubWidthC \qquad ( 990 )$$

$$nH = ( cIdx == 0 ) ? nCbH : nCbH * SubHeightC \qquad ( 991 )$$

$$shift1 = Max ( 5 , 17 - BitDepth ) \qquad ( 992 )$$

$$offset1 = 1 << ( shift1 - 1 ) \qquad ( 993 )$$

$$displacementX = angleIdx \qquad ( 994 )$$

$$displacementY = ( angleIdx + 8 ) \% 32 \qquad ( 995 )$$

$$partFlip = ( angleIdx >= 13 \&\& angleIdx <= 27 ) ? 0 : 1 \qquad ( 996 )$$

$$shiftHor = ( angleIdx \% 16 == 8 \vert \vert = ( angleIdx \% 16 != 0 \&\& nH >= nW ) ) ? 0 : 1 \qquad ( 997 )$$

The variables offsetX and offsetY are derived as follows:
If shiftHor is equal to 0, the following applies:

$$offsetX = ( - nW ) >> 1 \qquad ( 998 )$$

$$offsetY = ( ( - nH ) >> 1 ) + ( angleIdx < 16 ? ( distanceIdx * nH ) >> 3 : - ( ( distanceIdx * nH ) >> 3 ) ) \qquad ( 999 )$$

Otherwise (shiftHor is equal to 1), the following applies:

$$offsetX = ( ( - nW ) >> 1 ) + ( angleIdx < 16 ? ( distanceIdx * nW ) >> 3 : - ( ( distanceIdx * nW ) >> 3 ) ) \qquad ( 1000 )$$

$$offsetY = ( - nH ) >> 1 \qquad ( 1001 )$$

The prediction samples pbSamples [x] [y] with x=0 . . . nCbW−1 and y=0 . . . nCbH−1 are derived as follows:
The variables xL and yL are derived as follows:

$$xL = ( cIdx == 0 ) ? x : x * SubWidthC \qquad ( 1002 )$$

$$yL = ( cIdx == 0 ) ? y : y * SubHeightC \qquad ( 1003 )$$

The variable wValue specifying the weight of the prediction sample is derived based on the array disLut specified in Table 37 as follows:

$$weightIdx = ( ( ( xL + offsetX ) << 1 ) + 1 ) * disLut [ displacementX ] + ( ( ( yL + offsetY ) << 1 ) + 1 ) * disLut [ displacementY ] \qquad ( 1004 )$$

$$weightIdxL = partFlip ? 32 + weightIdx : 32 - weightIdx \qquad ( 1005 )$$

$$wValue = Clip3 ( 0 , 8 , ( weightIdxL + 4 ) >> 3 ) \qquad ( 1006 )$$

The prediction sample values are derived as follows:

$$pbSamples [ x ] [ y ] = Clip3 ( 0 , ( 1 << BitDepth ) - 1 , ( predSamplesLA [ x ] [ y ] * wValue + predSamplesLB [ x ] [ y ] * ( 8 - wValue ) + offset1 ) >> shift1 ) \qquad ( 100 \; 7 )$$

TABLE 37
of JVET-T2001 - Specification of the geometric partitioning distance array disLut.

| idx | 0 | 2 | 3 | 4 | 5 | 6 | 8 | 10 | 11 | 12 | 13 | 14 |
|---|---|---|---|---|---|---|---|---|---|---|---|---|
| disLut[idx] | 8 | 8 | 8 | 4 | 4 | 2 | 0 | −2 | −4 | −4 | −8 | −8 |
| idx | 16 | 18 | 19 | 20 | 21 | 22 | 24 | 26 | 27 | 28 | 29 | 30 |
| disLut[idx] | −8 | −8 | −8 | −4 | −4 | −2 | 0 | 2 | 4 | 4 | 8 | 8 |

Template matching based reordering for GPM split modes is now discussed. Video encoder 200 or video decoder 300 may implement such template matching based reordering.

In template matching based reordering for GPM split modes, given the motion information of the current GPM block, the respective template matching TM cost values of GPM split modes may be computed. Then, all GPM split modes may be reordered in ascending ordering based on the TM cost values. Instead of sending GPM split mode, an index using Golomb-Rice code to indicate where the exact GPM split mode located in the reordering list may be signaled.

The reordering technique for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 split modes as available split modes.

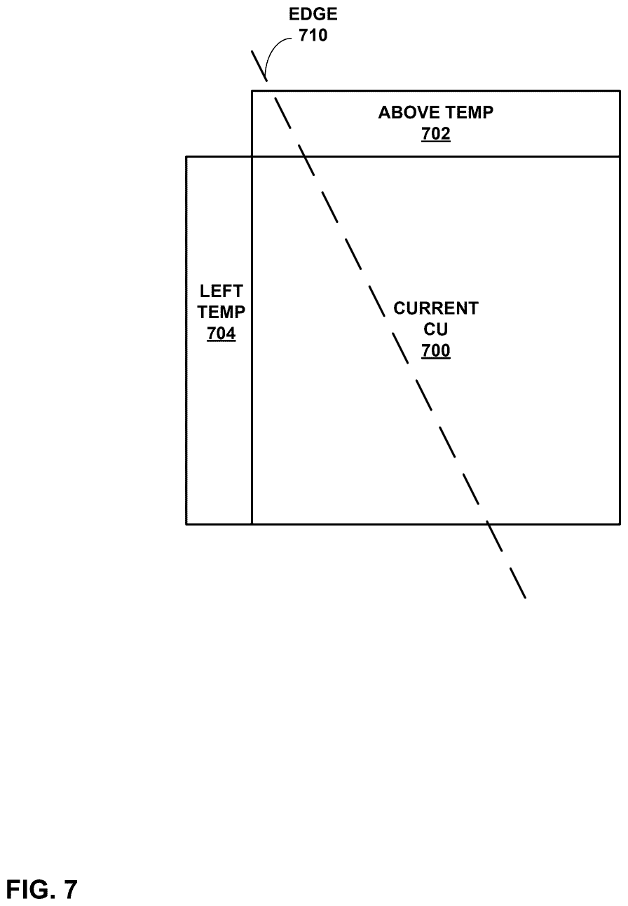

FIG. 7 is a conceptual diagram illustrating an example of an edge on templates. Current CU 700 may have an above template 702 and a left template 704. Edge 710, which may be a GPM edge, may be extended from current CU 700 through any templates, such as through above template 702 as depicted. However, a GPM blending process may not be used in the template area across the edge. After ascending reordering using TM cost, an index may be signaled.

GPM with adaptive blending is now described. Video encoder 200 or video decoder 300 may implement GPM with adaptive blending.

In VVC, the final prediction samples may be generated by blending the prediction of the two prediction signals using a weighted average. Two integer blending matrices (W₀ and W₁) may be used. The weights in the GPM blending matrices may be derived from the ramp function based on the displacement from a predicted sample position to the GPM partitioning boundary. The blending area size may be fixed to two (2 samples on each side of the GPM partition split boundary).

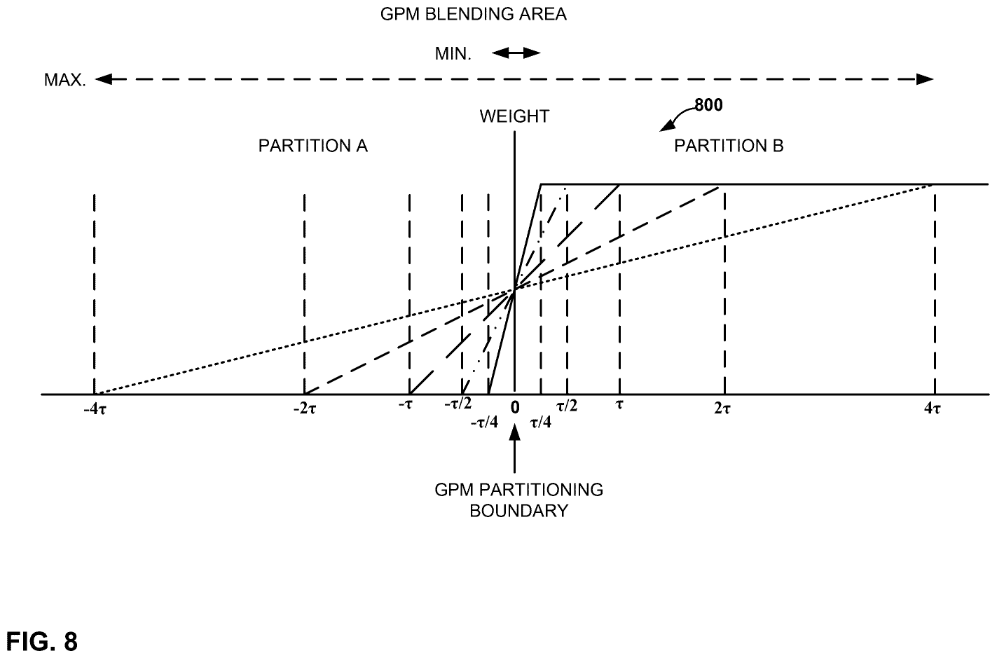

FIG. 8 is a conceptual diagram illustrating an example of geometric partitioning mode blending. The blending process in ECM is improved by adding four extra blending area sizes (quarter, half, double, and quadrupole of the existing area size) as shown in FIG. 8. FIG. 8 shows the ramp functions 800 for the weights for GPM blending based on the displacement (d) from a predicted sample position to the GPM partitioning boundary and the blending area size (t). A CU level flag may be coded and signaled to indicate the selected blending area. Furthermore, the extended weighting precision may be utilized, in which the maximum value of the weighs is changed from 8 (in VVC) to 32 to accommodate the extended blending area sizes.

GPM with TM is now described. Video encoder 200 or video decoder 300 may implement GPM with TM.

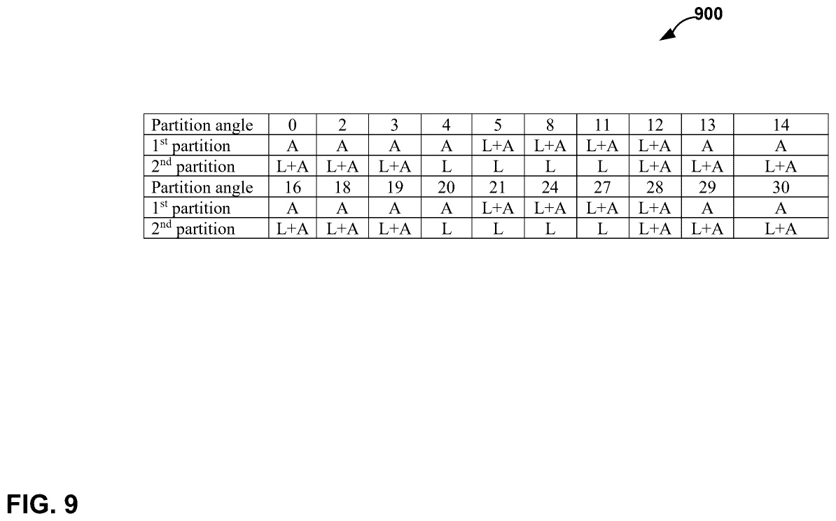

FIG. 9 is a table illustrating example templates for geometric partitions. TM may be applied to GPM. When GPM mode is enabled for a CU, a CU-level flag may be signaled to indicate whether TM is applied to both geometric partitions. Motion information for each geometric partition may be refined using TM. When TM is chosen, a template may be constructed using left, above, or left and above neighboring samples according to a partition angle, as shown in table 900 in FIG. 9. Table 900 of FIG. 9 shows the template for the 1st and 2nd geometric partitions, where A represents using above samples, L represents using left samples, and L+A represents using both left and above samples. The motion may then be refined by minimizing the difference between the current template and the template in the reference picture using the same search pattern of merge mode with a half-pel interpolation filter disabled.

A GPM candidate list may be constructed as follows:
Interleaved List-0 MV candidates and List-1 MV candidates are derived directly from the regular merge candidate list, where List-0 MV candidates are higher priority than List-1 MV candidates. A pruning technique with an adaptive threshold based on the current CU size may be applied to remove redundant MV candidates.
Interleaved List-1 MV candidates and List-0 MV candidates may be further derived directly from the regular merge candidate list, where List-1 MV candidates are higher priority than List-0 MV candidates. The same pruning technique with the adaptive threshold may also be applied to remove redundant MV candidates.
Zero MV candidates may be padded until the GPM candidate list is full.

The GPM-MMVD (merge mode with motion vector difference) and GPM-TM may be exclusively enabled to one GPM CU. This may be performed by first signaling the GPM-MMVD syntax. When both two GPM-MMVD control flags are equal to false (i.e., the GPM-MMVD are disabled for two GPM partitions), the GPM-TM flag may be signaled to indicate whether the template matching is applied to the two GPM partitions. Otherwise (at least one GPM-MMVD flag is equal to true), the value of the GPM-TM flag may be inferred to be false.

Adaptive reordering of merge candidates (ARMC) is now discussed. Video encoder 200 or video decoder 300 may implement ARMC.

In ECM, the merge candidates may be adaptively reordered with TM. The reordering techniques may be applied to regular merge candidate list, TM merge candidate list, and affine merge candidate list (subblock merge candidate list excluding the SbTMVP candidate). For the TM merge mode, merge candidates may be reordered before the TM refinement process.

After a merge candidate list is constructed, merge candidates may be divided into several subgroups. The subgroup size is set to 5 for regular merge mode and TM merge mode. The subgroup size is set to 3 for affine merge mode. Merge candidates in each subgroup may be reordered ascendingly according to cost values based on TM. For simplification, merge candidates in the last, but not the first, subgroup may not be reordered.

The TM cost of a merge candidate may be measured by the sum of absolute differences (SAD) between samples of a template of the current block and their corresponding reference samples. The template comprises a set of reconstructed samples neighboring to the current block. Reference samples of the template are located by the motion information of the merge candidate.

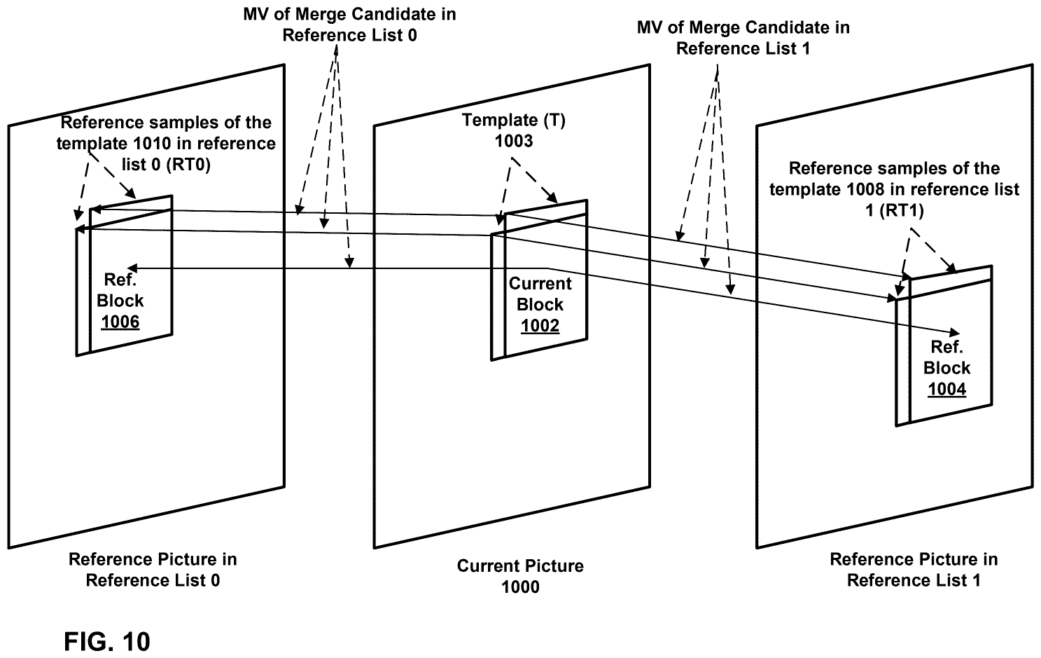

FIG. 10 is a conceptual diagram illustrating an example of template matching. When a merge candidate utilizes bi-directional prediction, the reference samples of the template of the merge candidate may also be generated by bi-prediction as shown in FIG. 10. For example, FIG. 10 illustrates current picture 1000 having current block 1002, and template 1003 that includes samples above and left of current block 1002. A first motion vector points to reference block 1004 that defines a first reference template 1008 that includes samples above and left of reference block 1004. A second motion vector points to reference block 1006 that defines a second reference template 1010 that includes samples above and left of reference block 1006.

For subblock-based merge candidates with subblock size equal to Wsub×Hsub, the above template comprises several sub-templates with the size of Wsub×1, and the left template comprises several sub-templates with the size of 1× Hsub.

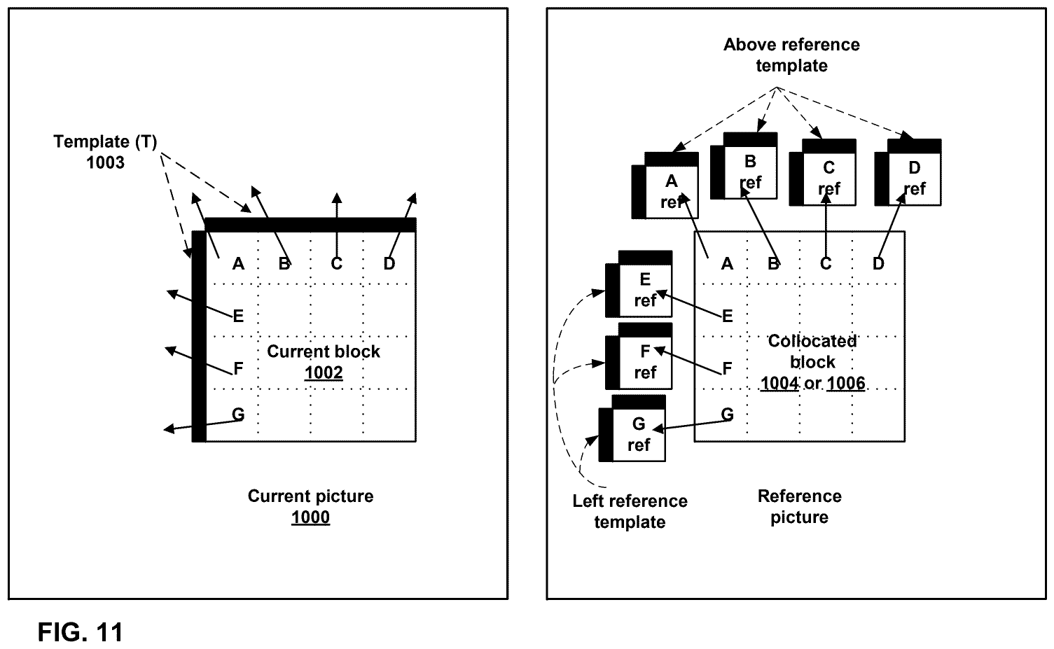

FIG. 11 is a conceptual diagram illustrating an example of sub-block based template matching. As shown in FIG. 11, the motion information of the subblocks in the first row and the first column of current block 1102 of current picture 1000 is used to derive the reference samples of each sub-template.

For instance, in FIG. 11, the collocated block may be reference block 1004 or 1006 of FIG. 10. Reference template 1008 or 1010, of FIG. 10, as illustrated in FIG. 11, may include samples above and left of reference block 1004 or 1006.

Merge mode functions under an assumption that a current block shares the same motion characteristics with a neighboring block, but cannot be efficiently partitioned in a frame due to the limitation of the rigid partitioning structure in the frame or picture. Thus, when a merge mode is used for a coding block, the coding block should have the same motion information, including the LIC model parameters and LIC flag, as the neighboring block from where motion information is inferred. However, the LIC flag is the only information inferred and the LIC model parameters of the current block are re-derived. This breaks the assumption of how merge modes should work and potentially introduces negative impact on coding performance and complexity. For example, because LIC model parameters for a current block in merge mode are re-derived, rather than inferred or inherited, a video encoder and/or video decoder may be more complex than necessary and such re-derivation may cause latency and/or video quality issues.

For ease of description, if not otherwise stated, the examples and techniques described below may be applied to inter prediction modes, intra block copy (IBC) modes, and/or intra template matching (IntraTMP) modes.

LIC model parameter inference from neighboring coded blocks is now described. In one example, when the current block is coded using the motion information inferred from a neighboring block, non-adjacent block, or temporal block in a spatio-temporal causal neighborhood relative to the current block, video encoder 200 and video decoder 300 may be configured to infer the LIC model parameters from the neighboring block, non-adjacent block, or temporal block, in addition to inferring the LIC flag value. When the inferred LIC flag is false, a predetermined or trivial model (e.g., 32 for α and 0 for β) may be used.

For example, video encoder 200 may encode a second block of the video data including applying LIC using a plurality of LIC parameters. Video encoder 200 may signal a LIC flag, a value of the LIC flag being indicative of LIC being applied to the second block. Video encoder 200 may determine to encode a current block of the video data using motion information of the second block. Video encoder 200 may encode the current block using the motion information of the second block and the plurality of LIC parameters.

For example, video decoder 300 may determine to decode a current block of the video data using motion information of a second block of the video data. Video decoder 300 may determine a value of a LIC flag of the second block, the value of the LIC flag of the second block indicative of LIC being applied to the second block. Video decoder 300 may determine, based on the value of the LIC flag, to apply LIC to the current block. Video decoder 300 may infer LIC model parameters of the current block to be equal to LIC model parameters of the second block. Video decoder 300 may decode the current block including using the inferred LIC model parameters and the motion information of the second block.

In another example that is similar to the above example, video encoder 200 and video decoder 300 are configured to infer the NLIC model parameters. For example, video encoder 200 and video decoder 300 may infer the NLIC model parameters from the neighboring block, non-adjacent block, or temporal block. In the bi-prediction case, the NLIC model parameters can be either applied directly to the final bi-prediction samples or applied separately to each prediction hypothesis before the prediction hypotheses combine together to form bi-prediction samples, depending on the choice of implementation.

For example, video encoder 200 may encode a second block of the video data including applying NLIC using a plurality of NLIC parameters. Video encoder 200 may signal an NLIC flag, a value of the NLIC flag being indicative of NLIC being applied to the second block. Video encoder 200 may determine to encode a current block of the video data using motion information of the second block. Video encoder 200 may encode the current block using the motion information of the second block and the plurality of NLIC parameters.

For example, video decoder 300 may determine to decode a current block of the video data using motion information of a second block of the video data. Video decoder 300 may determine a value of a NLIC flag of the second block, the value of the NLIC flag of the second block indicative of NLIC being applied to the second block. Video decoder 300 may determine, based on the value of the NLIC flag, to apply NLIC to the current block. Video decoder 300 may infer NLIC model parameters of the current block to be equal to NLIC model parameters of the second block. Video decoder 300 may decode the current block including using the inferred NLIC model parameters and the motion information of the second block.

In another example, which may be applied with or without the above examples, when the LIC flag is true, video encoder 200 and video decoder 300 may apply a model competition process when both LIC and NLIC model parameters co-exist. The LIC and NLIC model parameters may be applied separately to the reference template blocks and the respective results of both models may be compared with the current template block using certain template matching cost (e.g., the TM cost used in ARMC as described above). The model with lower TM cost may be selected.

In another example in addition to the example above, video encoder 200 and video decoder 300 compute another TM cost without any LIC model applied. This special TM cost is compared with the best TM cost one derived in example (3), and the following may apply:
if this special TM cost is the lowest TM cost, the LIC flag is set equal to false and LIC model parameters would be set equal to a trivial model;
otherwise, if this special TM cost is not the lowest TM cost or is higher than the other two TM costs, the LIC flag is set equal to true and the model parameters of either LIC or NLIC are chosen, according to example set forth above.

In another example, video encoder 200 and video decoder 300 may reconfigure the LIC flag to false for a merge candidate if a trivial model is used for each prediction hypothesis. A model may be considered trivial if at least one of the model parameters are not at least a predetermined value, if all of the model parameters are not at least respective predetermined values, if the effect of application of the model parameters is not at least a predetermined amount of effect, or the like. For example, video decoder 300 may determine to decode a second current block of the video data using motion information of a third block of the video data. Video decoder 300 may determine a value of a LIC flag of the third block, the value of the LIC flag of the third block indicative of LIC being applied to the third block. Video decoder 300 may determine that LIC model parameters of the third block are trivial. Video decoder 300 may set, based on the LIC model parameters of the third block being trivial, a LIC flag of the second current block to a value indicative of LIC not being applied to the second current bloc. Video decoder 300 may decode the second current block using the motion information of the third block without applying LIC.

In an example, when the LIC flag is true for a coding unit, video encoder 200 and video decoder 300 may store the inferred model parameters in the motion field and so they may be inferred by subsequent coding blocks. Similarly, even the trivial model used when LIC flag is false may be stored in the motion field and could be inferred by subsequent coding blocks.

Extensions to geometric merge mode (GEO) are now described. GEO was one of the coding modes without LIC enabled in ECM. This section describes techniques for extending the motion of LIC and NLIC to GEO merge mode. Any of, any combination of, or all of the techniques described above may also be used with the techniques described below.

In one example, during the GEO merge list construction process, video encoder 200 and video decoder 300 may infer LIC model parameters and LIC flag in addition to motion information.

In another example, during the GEO merge list construction process, video encoder 200 and video decoder 300 are configured to also infer NLIC model parameters and a LIC flag in addition to motion information. It is noted that, unlike LIC which has separate LIC models for each prediction hypothesis of a bi-prediction block, NLIC shares its model parameters across both prediction hypotheses of a bi-prediction block.

In another example, the same model competition as disclosed above concerning LIC may apply.

In an example, video encoder 200 and video decoder 300 may be configured to reconfigure the LIC flag to false for a GEO merge candidate if a trivial model is used for each prediction hypothesis.

In an example, since there are two partitions in GEO, when both are inter-prediction partitions, video encoder 200 and video decoder 300 store the LIC flag value and the corresponding LIC model parameters of each partition in the corresponding partitioning area in the motion field. In the blending area, the LIC flag stored is set equal to true if one of the partitions has a LIC flag value equal to true, and the LIC model parameters are averaged when necessary. It is noted that when one partition has only one prediction hypothesis on a reference list X picture and the other partition does not have such a prediction hypothesis, the model parameters for the other partition corresponding to reference list X picture are directly inferred without the need of averaging (e.g., X could be 0 or 1).

In another example, which may be considered a simplified version of the example above, the LIC flag value and model parameters of a partition is stored in the motion field.
If only one of the GEO partitions is of inter prediction, its LIC flag and LIC model parameters are stored in the motion field of the current block.
Otherwise, if both GEO partitions are of inter prediction, only the first (or the second depending on implementation choice) partition's LIC flag and LIC model parameters are stored in the motion field of the current block.

In another example, the template matching cost that is used in the template matching process of GEO candidates should consider LIC model parameters when LIC flag is true. It is known that ECM applies mean-removal SAD as a matching metric when a LIC flag is true. This example applies LIC model parameters to each reference block that a template matching process visits before TM cost is computed, and the matching metrics may be SAD:

$$TM cost = {\sum }_{x} \vert c [ x ] - ( α * p [ x + v ] + β ) \vert ,$$

where c[x] is a current template block sample at position x, p[x] is c[x]'s reference template block pointed to by a motion vector v, and a and B are inferred model parameters (either from LIC model or NLIC model).

In another example, which may be considered a simplified version of the example immediately above, instead of applying model parameters to a reference template block when LIC flag is true, video encoder 200 and video decoder 300 applies an inverse model to the current template block and thus there is no need to apply LIC model parameters to each of the reference template blocks visited. For example, video decoder 300 may determine LIC parameters of a third block. Video decoder 300 may determine an inverse of the LIC parameters. Video decoder 300 may apply the inverse of the LIC parameters to a template of second current block. Video decoder 300 may decode the second current block based on the applying the inverse of the LIC parameters to the template of the second current block.

The matching metrics may still be SAD. The inverse model with parameters α′=1/α and β′=−β/α may be derived conceptually and mathematically as follows:

$$\begin{matrix}TM cost = {\sum }_{x} \vert c [ x ] - ( α * p [ x + v ] + β ) \vert \\ = α * {\sum }_{x} \vert ( ( c [ x ] - β ) / α ) - p [ x + v ] \vert \\ = α * {\sum }_{x} \vert ( 1 / α * c [ x ] - β / α ) - p [ x + v ] \vert \\ = α * {\sum }_{x} \vert ( {α}^{′} * c [ x ] + {β}^{′} ) - p [ x + v ] \vert . \\ = α * Inverse TM cost .\end{matrix}$$

Since the inverse model, α′*c[x]+β′, is actually the same mathematical form as what is applied to reference template block (α*p[x+v]+β defined), the same hardware model can thus be re-used to support this inverse model process. In addition, an integer-precision implementation for the inverse model and the respective TM cost is given as follows:

$$invAlpha = ( ( 1 << ( shift + invShift ) ) + ( alpha > 0 ? ( alpha >> 1 ) : - ( alpha >> 1 ) ) ) / alpha$$

$$invBeta = ( ( - beta * invAlpha ) + ( 1 << ( invShift - 1 ) ) ) >> invShift$$

$$TM Cost = ( Inverse TM Cost * alpha + ( 1 << ( shift - 1 ) ) ) >> shift ,$$

where shift (typically 5) is the integer precision used to represent α (e.g., 32 and 16 represent respectively for 1.0 and 0.5), invShift (typically 16) is the integer precision used to represent α′, invAlpha and invBeta denote respectively for α′ and β′.

In another example, LIC usage is not determined independently across partitions, but is jointly optimized after two partitions on reference template block are blended when given a split mode. Video encoder 200 and video decoder 300 may implement such techniques. Without loss of generality, assume each partition always has LIC model parameters inferred from a merge candidate, and thus each partition has three versions reference template samples (e.g., one without LIC applied, another with LIC model applied, and the last with NLIC model applied). Either one of the models can be ignored if not existing. For simplicity, they are denoted respectively by using T_{off}, T_{LIC}, and T_{NLIC}, and given a split mode the blending results of two partitions on reference template area are denoted as T_{a,b}, where a and b can be off, LIC, and NLIC. Then, the current block template is compared with each of the T_{a,b} and the one with smallest TM cost is selected. For example, if T_{off,LIC} is selected, then the LIC flag of the first partition is set equal to false with a trivial model parameters stored and the LIC flag of the second partition is set equal to true with inferred LIC model parameter from a merge candidate.

In another example, which may be used in conjunction with the example above, when higher complexity is affordable, LIC usage on each partition may be optimized jointly with split modes. Video encoder 200 and video decoder 300 may implement such techniques. As described above, given the motion information of each partition, ECM reorders the GEO split modes through TM cost and one of first few best split modes with lowest TM costs is indicates in bitstream for split mode selection. Since there are 64 split modes, a total of 64 reference template blocks are blended for TM cost computation. This example adds extra degree of freedom for each partition to choose among LIC disabled, inferred LIC model, and inferred NLIC model. Thus, at most 3*3*64 possibilities are reordered based on their respective TM cost values, and then similarly, an index is indicated in bitstream to pick up one from the first N best candidates that reach lower TM cost than the others'.

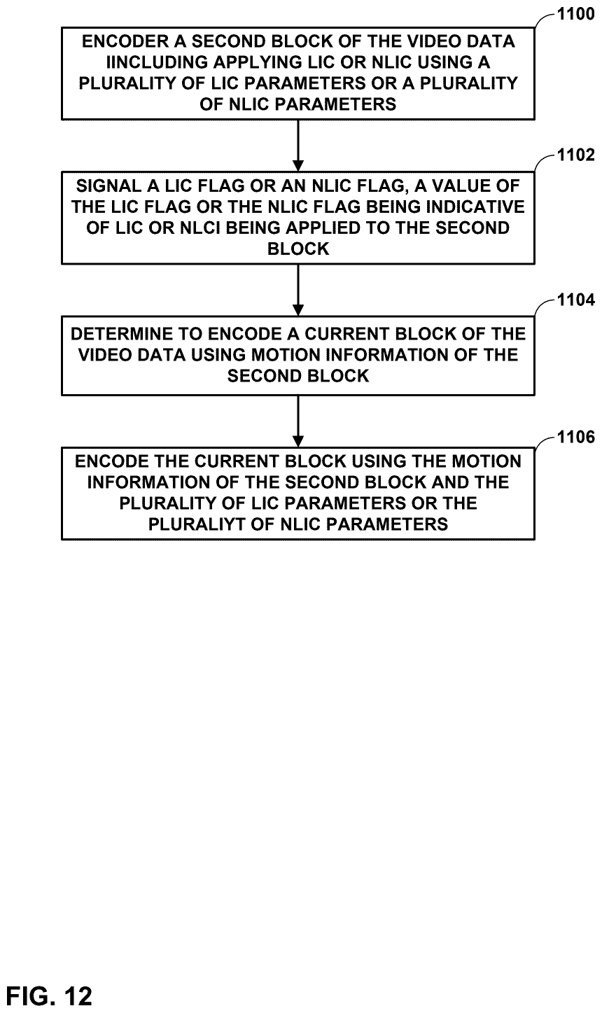

FIG. 12 is a flowchart illustrating example LIC inheritance techniques according to one or more aspects of this disclosure. Video encoder 200 may encode a second block of the video data including applying LIC or NLIC using a plurality of LIC parameters or a plurality of NLIC parameters (1100). For example, video encoder 200 may determine to apply LIC to a block of video data and encode the block using a plurality of LIC parameters. For example, video encoder 200 may determine to apply NLIC to a block of video data and encode the block using a plurality of NLIC parameters.

Video encoder 200 may signal a LIC flag or an NLIC flag, a value of the LIC flag or NLIC flag being indicative of LIC or NLIC being applied to the second block (1102). For example, video encoder 200 may signal, in a bitstream, a flag that has a value that indicates that video decoder 300 should apply LIC when decoding the second block. For example, video encoder 200 may signal, in a bitstream, a flag that has a value that indicates that video decoder 300 should apply NLIC when decoding the second block.

Video encoder 200 may determine to encode a current block of the video data using motion information of the second block (1104). For example, video encoder 200 may determine that the current block should be encoded using the motion information of the second block.

Video encoder 200 may encode the current block using the motion information of the second block and the plurality of LIC parameters or the plurality of NLIC parameters (1106).

In some examples, as part of encoding the current block, video encoder 200 may use the motion information of the second block for one of an inter prediction mode, an intra block copy mode, an intra template matching mode, or a geometric mode. In some examples, the second block of video data is a neighboring block, a non-adjacent block, or a temporal block in a spatio-temporal causal neighborhood, of the current block.

In some examples, the current block is a first current block. In some examples, video encoder 200 may determine LIC parameters of a third block. Video encoder 200 may determine an inverse of the LIC parameters. Video encoder 200 may apply the inverse of the LIC parameters to a template of second current block. Video encoder 200 may encode the second current block based on the applying the inverse of the LIC parameters to the template of the second current block.

In some examples, video encoder 200 includes a camera configured to capture the video data.

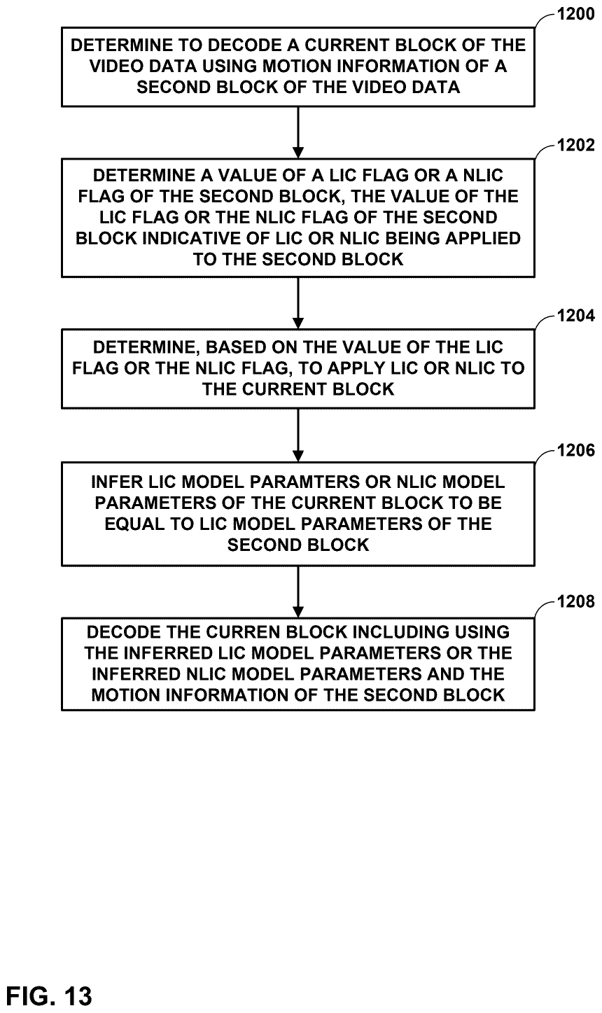

FIG. 13 is a flowchart illustrating additional example LIC inheritance techniques according to one or more aspects of this disclosure. Video decoder 300 may determine to decode a current block of the video data using motion information of a second block of the video data (1200). For example, video decoder 300 may parse a syntax element in a bitstream signaled by video encoder 200 that indicates the current block is encoded using motion information of another block of the video data.

Video decoder 300 may determine a value of a LIC flag or an NLIC flag of the second block, the value of the LIC flag or NLIC flag of the second block indicative of LIC or NLIC being applied to the second block (1202). For example, video decoder 300 may determine that a LIC flag, which may be stored in the one or more memories, for the second block indicates that LIC is/was applied to the second block. For example, video decoder 300 may determine that an NLIC flag, which may be stored in the one or more memories, for the second block indicates that NLIC is/was applied to the second block.

Video decoder 300 may determine, based on the value of the LIC flag or NLIC flag, to apply LIC or NLIC to the current block (1204). For example, because the LIC flag indicates LIC is/was applied to the second block, video decoder 300 may determine to apply LIC to the current block. In other words, the application of LIC to the current block is inferred, inherited, or derived from the application of LIC to the second block. For example, because the NLIC flag indicates NLIC is/was applied to the second block, video decoder 300 may determine to apply NLIC to the current block. In other words, the application of NLIC to the current block is inferred, inherited, or derived from the application of NLIC to the second block.

Video decoder 300 may infer LIC model parameters or NLIC model parameters of the current block to be equal to LIC model parameters or NLIC model parameters of the second block (1206). For example, video decoder 300 may also infer the LIC model parameters of the second block for the current block, not only infer the motion information and the LIC flag. For example, video decoder 300 may also infer the NLIC model parameters of the second block for the current block, not only infer the motion information and the NLIC flag.

Video decoder 300 may decode the current block including using the inferred LIC model parameters or the inferred NLIC model parameters and the motion information of the second block (1208).

In some examples, as part of decoding the current block, video decoder 300 may use the motion information of the second block for one of an inter prediction mode, an intra block copy mode, an intra template matching mode, or a geometric mode. In some examples, the second block of video data is a neighboring block, a non-adjacent block, or a temporal block in a spatio-temporal causal neighborhood, of the current block.

In some examples, as part of decoding the current block using the inferred LIC model parameters or the NLIC model parameters and the motion information of the second block, video decoder 300 may perform a model competition process between LIC model parameters and NLIC model parameters. In some examples, as part of performing the model competition process, video decoder 300 may determine a template matching cost associated with applying LIC to a reference template block. Video decoder 300 may determine a template matching cost associated with applying NLIC to the reference template block. Video decoder 300 may determine that the template matching cost associated with applying LIC is lower than the template matching cost associated with applying NLIC.

In some examples, as part of decoding the current block using the inferred LIC model parameters or the inferred NLIC model parameters and the motion information of the second block, video decoder 300 may determine a template matching cost associated with not applying LIC to the reference template block. Video decoder 300 may determine that the template matching cost associated with applying LIC to the reference template block is less than the template matching cost associated with not applying LIC to the reference template block.

In some examples, the current block is a first current block. In some examples, video decoder 300 may determine to decode a second current block of the video data using motion information of a third block of the video data. Video decoder 300 may determine a value of a LIC flag of the third block, the value of the LIC flag of the third block indicative of LIC being applied to the third block. Video decoder 300 may determine that LIC model parameters of the third block are trivial. Video decoder 300 may set, based on the LIC model parameters of the third block being trivial, a LIC flag of the second current block to a value indicative of LIC not being applied to the second current block. Video decoder 300 may decode the second current block using the motion information of the third block without applying LIC.

In some examples, video decoder 300 may store the LIC model parameters in memory for use with subsequent blocks of video data. In some examples, video decoder 300 may determine that at least one partition of a geometric mode (GEO) block is inter predicted. Video decoder 300 may store, based on at least one partition of the GEO block being inter predicted, a LIC flag value and LIC parameters of one of the at least one partition of the GEO block in memory.

In some examples, the current block is a first current block. In some examples, video decoder 300 may determine LIC parameters of a third block. Video decoder 300 may determine an inverse of the LIC parameters. Video decoder 300 may apply the inverse of the LIC parameters to a template of second current block. Video decoder 300 may decode the second current block based on the applying the inverse of the LIC parameters to the template of the second current block.

In some examples, video decoder 300 may include a display configured to display decoded video data.

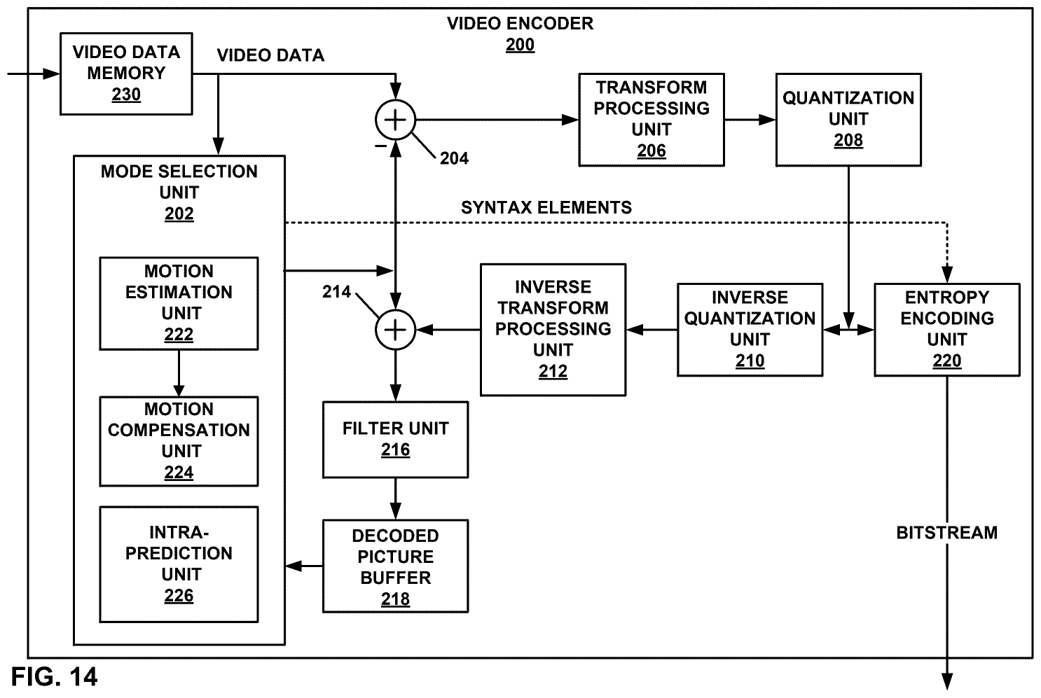

FIG. 14 is a block diagram illustrating an example video encoder 200 that may perform the techniques of this disclosure. FIG. 14 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 14, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 14 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2NxnU, 2NxnD, nLx2N, and nRx2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device including one or more memories configured to store video data and one or more processing units implemented in circuitry and configured to encode a second block of the video data including applying LIC using a plurality of LIC parameters; signal a LIC flag, a value of the LIC flag being indicative of LIC being applied to the second block; determine to encode a current block of the video data using motion information of a second block of the video data; and encode the current block using the motion information of the second block and the plurality of LIC parameters.

Video encoder 200 also represents an example of a device including one or more memories configured to store video data and one or more processing units implemented in circuitry and configured to encode a second block of the video data including applying NLIC using a plurality of NLIC parameters; signal an NLIC flag, a value of the NLIC flag being indicative of NLIC being applied to the second block; determine to encode a current block of the video data using motion information of a second block of the video data; and encode the current block using the motion information of the second block and the plurality of NLIC parameters.

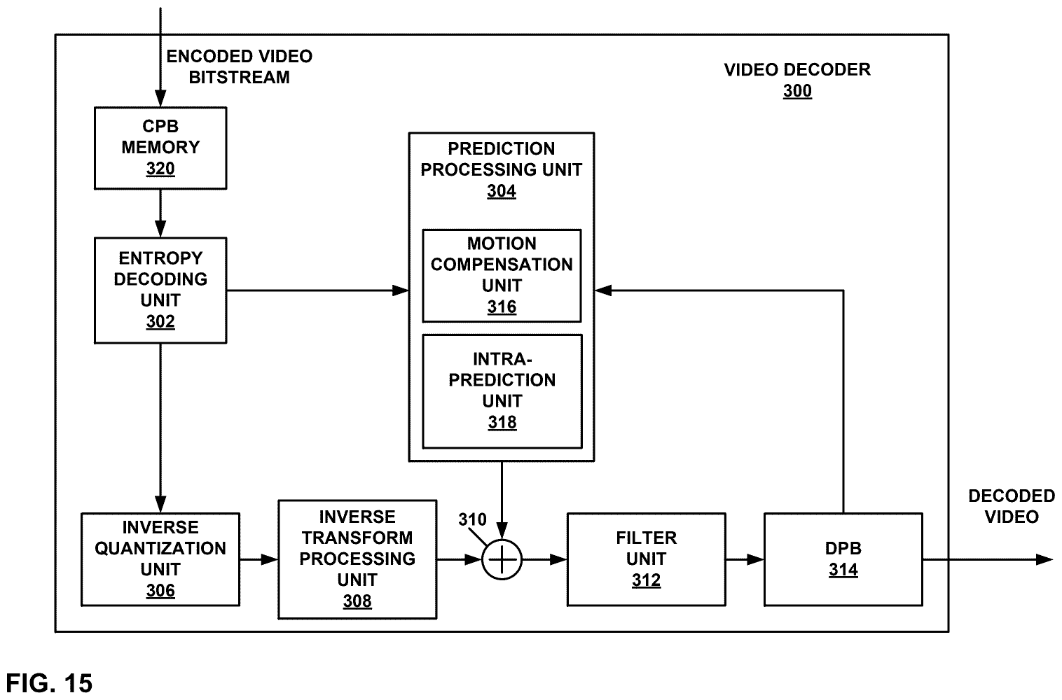

FIG. 15 is a block diagram illustrating an example video decoder 300 that may perform the techniques of this disclosure. FIG. 15 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 15, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 15 are illustrated to assist with understanding the operations performed by video decoder 300. The units may be implemented as fixed-function circuits, programmable circuits, or a combination thereof. Similar to FIG. 14, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 14).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 14). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including one or more memories configured to store video data, and one or more processing units implemented in circuitry and configured to determine to decode a current block of the video data using motion information of a second block of the video data; determine a value of a LIC flag of the second block, the value of the LIC flag of the second block indicative of LIC being applied to the second block; determine, based on the value of the LIC flag, to apply LIC to the current block; infer LIC model parameters of the current block to be equal to LIC model parameters of the second block; and decode the current block including using the inferred LIC model parameters and the motion information of the second block.

Video decoder 300 also represents an example of a video decoding device including one or more memories configured to store video data, and one or more processing units implemented in circuitry and configured to determine to decode a current block of the video data using motion information of a second block of the video data; determine a value of a NNLIC flag of the second block, the value of the NLIC flag of the second block indicative of NLIC being applied to the second block; determine, based on the value of the NLIC flag, to apply NLIC to the current block; infer NLIC model parameters of the current block to be equal to NLIC model parameters of the second block; and decode the current block including using the inferred NLIC model parameters and the motion information of the second block.

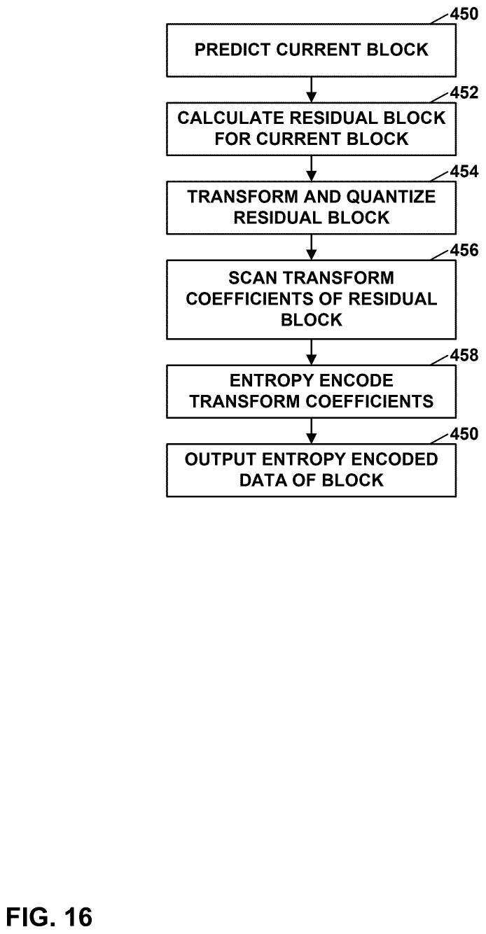

FIG. 16 is a flowchart illustrating an example method for encoding a current block in accordance with the techniques of this disclosure. The current block may be or include a current CU. Although described with respect to video encoder 200 (FIGS. 1 and 14), it should be understood that other devices may be configured to perform a method similar to that of FIG. 16.

In this example, video encoder 200 initially predicts the current block (450). For example, video encoder 200 may form a prediction block for the current block. Video encoder 200 may then calculate a residual block for the current block (452). To calculate the residual block, video encoder 200 may calculate a difference between the original, unencoded block and the prediction block for the current block. Video encoder 200 may then transform the residual block and quantize transform coefficients of the residual block (454). Next, video encoder 200 may scan the quantized transform coefficients of the residual block (456). During the scan, or following the scan, video encoder 200 may entropy encode the transform coefficients (458). For example, video encoder 200 may encode the transform coefficients using CAVLC or CABAC. Video encoder 200 may then output the entropy encoded data of the block (460).

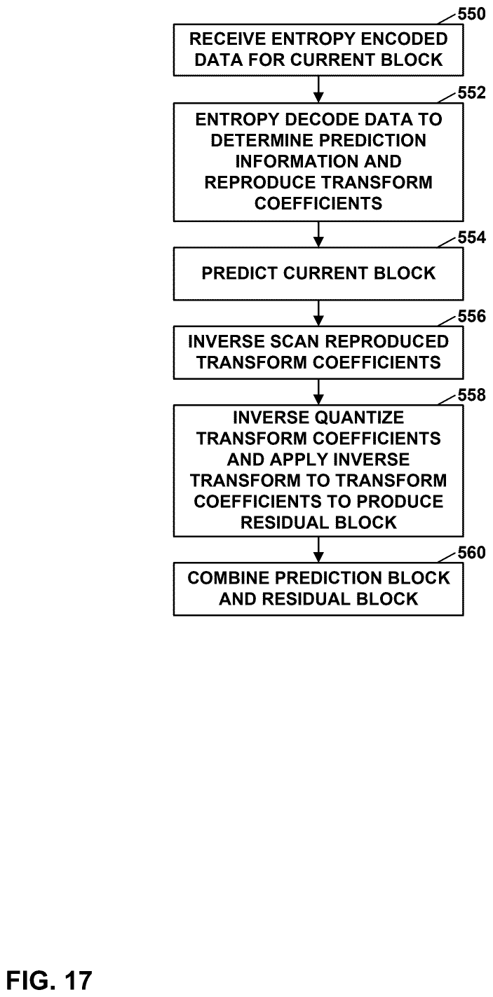

FIG. 17 is a flowchart illustrating an example method for decoding a current block of video data in accordance with the techniques of this disclosure. The current block may be or include a current CU. Although described with respect to video decoder 300 (FIGS. 1 and 15), it should be understood that other devices may be configured to perform a method similar to that of FIG. 17.

Video decoder 300 may receive entropy encoded data for the current block, such as entropy encoded prediction information and entropy encoded data for transform coefficients of a residual block corresponding to the current block (550). Video decoder 300 may entropy decode the entropy encoded data to determine prediction information for the current block and to reproduce transform coefficients of the residual block (552). Video decoder 300 may predict the current block (554), e.g., using an intra- or inter-prediction mode as indicated by the prediction information for the current block, to calculate a prediction block for the current block. Video decoder 300 may then inverse scan the reproduced transform coefficients (556), to create a block of quantized transform coefficients. Video decoder 300 may then inverse quantize the transform coefficients and apply an inverse transform to the transform coefficients to produce a residual block (558). Video decoder 300 may ultimately decode the current block by combining the prediction block and the residual block (560).

The following numbered clauses illustrate one or more aspects of the devices and techniques described in this disclosure.

Aspect 1A. A method of coding video data, the method comprising: receiving a current block of video data to be coded using motion information derived from a causal block of video data; inferring local illumination compensation (LIC) model parameters and an LIC flag from the causal block of video data; and coding the current block of video data using the LIC model parameters and the LIC flag.

Aspect 2A. The method of Aspect 1A, wherein the motion information is used for one of an inter prediction mode, an intra block copy mode, or an intra template matching mode.

Aspect 3A. The method of Aspect 1A, wherein the causal block of video data is a neighboring block, a non-adjacent block, or a temporal block in a spatio-temporal causal neighborhood.

Aspect 4A. The method of Aspect 1A, further comprising: performing a model competition process when both LIC model parameters and non-local illumination compensation (NLIC) model parameters are available for the current block.

Aspect 5A. The method of Aspect 1A, further comprising: determining the LIC flag to be false if the LIC model parameters are a trivial model.

Aspect 6A. The method of Aspect 1A, further comprising: storing the LIC model parameters in a memory for use with subsequent blocks of video data.

Aspect 7A. A method of coding video data, the method comprising: receiving a current block of video data to be coded using motion information derived from a causal block of video data; inferring non-local illumination compensation (NLIC) model parameters from the causal block of video data; and coding the current block of video data using the NLIC model parameters.

Aspect 8A. The method of Aspect 7A, wherein the motion information is used for one of an inter prediction mode, an intra block copy mode, or an intra template matching mode.

Aspect 9A. The method of Aspect 7A, wherein the causal block of video data is a neighboring block, a non-adjacent block, or a temporal block in a spatio-temporal causal neighborhood.

Aspect 10A. The method of Aspect 7A, further comprising: performing a model competition process when both LIC model parameters and NLIC model parameters are available for the current block.

Aspect 11A. The method of Aspect 7A, further comprising: determining the NLIC flag to be false if the NLIC model parameters are a trivial model.

Aspect 12A. The method of Aspect 7A, further comprising: storing the NLIC model parameters in a memory for use with subsequent blocks of video data.

Aspect 13A. A method of coding video data, the method comprising: receiving a current block of video data partitioned using a geometric partition mode (GEO); inferring motion information, local illumination compensation (LIC) model parameters, and an LIC flag during a GEO merge list construction process; coding the current block of video data using the inferred motion information, LIC model parameters, and LIC flag associated with a candidate in the GEO merge list.

Aspect 14A. The method of Aspect 13A, further comprising: performing a model competition process when both LIC model parameters and non-local illumination compensation (NLIC) model parameters are available for the current block.

Aspect 15A. A method of coding video data, the method comprising: receiving a current block of video data partitioned using a geometric partition mode (GEO); inferring motion information, non-local illumination compensation (NLIC) model parameters, and an NLIC flag during a GEO merge list construction process; coding the current block of video data using the inferred motion information, NLIC model parameters, and NLIC flag associated with a candidate in the GEO merge list.

Aspect 16A. The method of Aspect 15A, further comprising: performing a model competition process when both LIC model parameters and NLIC model parameters are available for the current block.

Aspect 17A. The method of any of Aspects 1A-16A, wherein coding comprises decoding.

Aspect 18A. The method of any of Aspects 1A-16A, wherein coding comprises encoding.

Aspect 19A. A device for coding video data, the device comprising one or more means for performing the method of any of Aspects 1-18.

Aspect 20A. The device of Aspect 19A, wherein the one or more means comprise one or more processors implemented in circuitry.

Aspect 21A. The device of any of Aspects 19A and 20A, further comprising a memory to store the video data.

Aspect 22A. The device of any of Aspects 19A-21A, further comprising a display configured to display decoded video data.

Aspect 23A. The device of any of Aspects 19A-22A, wherein the device comprises one or more of a camera, a computer, a mobile device, a broadcast receiver device, or a set-top box.

Aspect 24A. The device of any of Aspects 19A-23A, wherein the device comprises a video decoder.

Aspect 25A. The device of any of Aspects 19A-24A, wherein the device comprises a video encoder.

Aspect 26A. A computer-readable storage medium having stored thereon instructions that, when executed, cause one or more processors to perform the method of any of Aspect 1A-18A.

Aspect 1B. A method of decoding video data, the method comprising: determining to decode a current block of the video data using motion information of a second block of the video data; determining a value of a local illumination compensation (LIC) flag or a non-local illumination compensation (NLIC) flag of the second block, the value of the LIC flag or the NLIC flag of the second block indicative of LIC or NLIC being applied to the second block; determining, based on the value of the LIC flag or the NLIC flag, to apply LIC or NLIC to the current block; inferring LIC model parameters or NLIC model parameters of the current block to be equal to LIC model parameters or NLIC model parameters of the second block; and decoding the current block including using the inferred LIC model parameters or the inferred NLIC model parameters and the motion information of the second block.

Aspect 2B. The method of aspect 1B, wherein decoding the current block comprises using the motion information of the second block for one of an inter prediction mode, an intra block copy mode, an intra template matching mode, or a geometric mode.

Aspect 3B. The method of aspect 1B or aspect 2B, wherein the second block is a neighboring block, a non-adjacent block, or a temporal block in a spatio-temporal causal neighborhood, of the current block.

Aspect 4B. The method of any of aspects 1B-3B, wherein decoding the current block using the inferred LIC model parameters or the inferred NLIC model parameters and the motion information of the second block comprises performing a model competition process between the LIC model parameters and the NLIC model parameters.

Aspect 5B. The method of aspect 4B, wherein performing the model competition process comprises: determining a template matching cost associated with applying LIC to a reference template block; determining a template matching cost associated with applying NLIC to the reference template block; and determining that the template matching cost associated with applying LIC is lower than the template matching cost associated with applying NLIC.

Aspect 6B. The method of aspect 5B, wherein decoding the current block using the inferred LIC model parameters or the inferred NLIC model parameters and the motion information of the second block further comprises: determining a template matching cost associated with not applying LIC to the reference template block; and determining that the template matching cost associated with applying LIC to the reference template block is less than the template matching cost associated with not applying LIC to the reference template block.

Aspect 7B. The method of any of aspects 1B-6B, wherein the current block is a first current block, the method further comprising: determining to decode a second current block of the video data using motion information of a third block of the video data; determining a value of a LIC flag of the third block, the value of the LIC flag of the third block indicative of LIC being applied to the third block; determining that LIC model parameters of the third block are trivial; setting, based on the LIC model parameters of the third block being trivial, a LIC flag of the second current block to a value indicative of LIC not being applied to the second current block; and decoding the second current block using the motion information of the third block without applying LIC.

Aspect 8B. The method of any of aspects 1B-7B, further comprising storing the LIC model parameters or NLIC model parameters in memory for use with subsequent blocks of the video data.

Aspect 9B. The method of any of aspects 1B-8B, the method further comprising: determining that at least one partition of a geometric mode (GEO) block is inter predicted; and based on at least one partition of the GEO block being inter predicted, storing a LIC flag value and LIC model parameters of one of the at least one partition of the GEO block in memory.

Aspect 10B. The method of any of aspects 1B-9B, wherein the current block is a first current block, the method further comprising: determining LIC model parameters of a third block; determining an inverse of the LIC parameters; applying the inverse of the LIC parameters to a template of second current block; and decoding the second current block based on the applying the inverse of the LIC parameters to the template of the second current block.

Aspect 11B. A device for decoding video data, the device comprising: one or more memories configured to store the video data; and one or more processors operatively coupled to the one or more memories, the one or more processors configured to: determine to decode a current block of the video data using motion information of a second block of the video data; determine a value of a local illumination compensation (LIC) flag or a non-local illumination compensation (NLIC) flag of the second block, the value of the LIC flag or the NLIC flag of the second block indicative of LIC or NLIC being applied to the second block; determine, based on the value of the LIC flag of the NLIC flag, to apply LIC or NLIC to the current block; infer LIC model parameters or NLIC model parameters of the current block to be equal to LIC model parameters or NLIC model parameters of the second block; and decode the current block including using the inferred LIC model parameters or the inferred NLIC model parameters and the motion information of the second block.

Aspect 12B. The device of aspect 11B, wherein as part of decoding the current block, the one or more processors are configured to use the motion information of the second block for one of an inter prediction mode, an intra block copy mode, an intra template matching mode, or a geometric mode.

Aspect 13B. The device of aspect 11B or aspect 12B, wherein the second block is a neighboring block, a non-adjacent block, or a temporal block in a spatio-temporal causal neighborhood, of the current block.

Aspect 14B. The device of any of aspects 11B-13B, wherein as part of decoding the current block using the inferred LIC model parameters or the inferred NLIC model parameters and the motion information of the second block, the one or more processors are configured to perform a model competition process between LIC model parameters and NLIC model parameters.

Aspect 15B. The device of aspect 14B, wherein as part of performing the model competition process, the one or more processors are configured to: determine a template matching cost associated with applying LIC to a reference template block; determine a template matching cost associated with applying NLIC to the reference template block; and determine that the template matching cost associated with applying LIC is lower than the template matching cost associated with applying NLIC.

Aspect 16B. The device of aspect 15B, wherein as part of decoding the current block using the inferred LIC model parameters or the inferred NLIC model parameters and the motion information of the second block, the one or more processors are further configured to: determine a template matching cost associated with not applying LIC to the reference template block; and determine that the template matching cost associated with applying LIC to the reference template block is less than the template matching cost associated with not applying LIC to the reference template block.

Aspect 17B. The device of any of aspects 11B-16B, wherein the current block is a first current block, and wherein the one or more processors are further configured to: determine to decode a second current block of the video data using motion information of a third block of the video data; determine a value of a LIC flag of the third block, the value of the LIC flag of the third block indicative of LIC being applied to the third block; determine that LIC model parameters of the third block are trivial; set, based on the LIC model parameters of the third block being trivial, a LIC flag of the second current block to a value indicative of LIC not being applied to the second current block; and decode the second current block using the motion information of the third block without applying LIC.

Aspect 18B. The device of any of aspects 11B-17B, wherein the one or more processors are further configured to store the LIC model parameters or NLIC model parameters in the one or more memories for use with subsequent blocks of the video data.

Aspect 19B. The device of any of aspects 11B-18B, wherein the one or more processors are further configured to: determine that at least one partition of a geometric mode (GEO) block is inter predicted; and store, based on at least one partition of the GEO block being inter predicted, a LIC flag value and LIC parameters of one of the at least one partition of the GEO block in the one or more memories.

Aspect 20B. The device of any of aspects 11B-19B, wherein the current block is a first current block, and wherein the one or more processors are further configured to: determine LIC parameters of a third block; determine an inverse of the LIC parameters; apply the inverse of the LIC parameters to a template of second current block; and decode the second current block based on the applying the inverse of the LIC parameters to the template of the second current block.

Aspect 21B. The device of any of aspects 11B-20B, further comprising a display configured to display decoded video data.

Aspect 22B. A method of encoding video data, the method comprising: encoding a second block of the video data including applying local illumination compensation (LIC) or non-local illumination compensation (NLIC) using a plurality of LIC model parameters or a plurality of NLIC model parameters; signaling a LIC flag or an NLIC flag, a value of the LIC flag or the NLIC flag being indicative of LIC or NLIC being applied to the second block; determining to encode a current block of the video data using motion information of the second block; and encoding the current block using the motion information of the second block and the plurality of LIC parameters or the plurality of NLIC parameters.

Aspect 23B. The method of aspect 22B, wherein encoding the current block comprises using the motion information of the second block for one of an inter prediction mode, an intra block copy mode, an intra template matching mode, or a geometric mode.

Aspect 24B. The method of aspect 22B or aspect 23B, wherein the second block is a neighboring block, a non-adjacent block, or a temporal block in a spatio-temporal causal neighborhood, of the current block.

Aspect 25B. The method of any of aspects 22B-24B, wherein the current block is a first current block, the method further comprising: determining LIC parameters of a third block; determining an inverse of the LIC parameters; applying the inverse of the LIC parameters to a template of second current block; and encoding the second current block based on the applying the inverse of the LIC parameters to the template of the second current block.

Aspect 26B. A device for encoding video data, the device comprising: one or more memories configured to store the video data; and one or more processors operatively coupled to the one or more memories, the one or more processors configured to: encode a second block of the video data including applying local illumination compensation (LIC) or non-local illumination compensation (NLIC) using a plurality of LIC parameters or a plurality of NLIC parameters; signal a LIC flag or an NLIC flag, a value of the LIC flag or the NLIC flag being indicative of LIC or NLIC being applied to the second block; determine to encode a current block of the video data using motion information of the second block; and encode the current block using the motion information of the second block and the plurality of LIC parameters or the plurality of NLIC parameters.

Aspect 27B. The device of aspect 26B, wherein as part of encoding the current block, the one or more processors are configured to use the motion information of the second block for one of an inter prediction mode, an intra block copy mode, an intra template matching mode, or a geometric mode.

Aspect 28B. The device of aspect 26B or aspect 27B, wherein the second block is a neighboring block, a non-adjacent block, or a temporal block in a spatio-temporal causal neighborhood, of the current block.

Aspect 29B. The device of any of aspects 26B-28B, wherein the current block is a first current block, and wherein the one or more processors are configured to: determine LIC parameters of a third block; determine an inverse of the LIC parameters; apply the inverse of the LIC parameters to a template of second current block; and encode the second current block based on the applying the inverse of the LIC parameters to the template of the second current block.

Aspect 30B. The device of any of aspects 26B-29B, further comprising a camera configured to capture the video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining to decode a current block of the video data using motion information of a second block of the video data;
determining a value of a local illumination compensation (LIC) flag or a non-local illumination compensation (NLIC) flag of the second block, the value of the LIC flag or the NLIC flag of the second block indicative of LIC or NLIC being applied to the second block;
determining, based on the value of the LIC flag or the NLIC flag, to apply LIC or NLIC to the current block;
inferring LIC model parameters or NLIC model parameters of the current block to be equal to LIC model parameters or NLIC model parameters of the second block; and
decoding the current block including using the inferred LIC model parameters or the inferred NLIC model parameters and the motion information of the second block.

2. The method of claim 1, wherein decoding the current block comprises using the motion information of the second block for one of an inter prediction mode, an intra block copy mode, an intra template matching mode, or a geometric mode.

3. The method of claim 1, wherein the second block is a neighboring block, a non-adjacent block, or a temporal block in a spatio-temporal causal neighborhood, of the current block.

4. The method of claim 1, wherein decoding the current block using the inferred LIC model parameters or the inferred NLIC model parameters and the motion information of the second block comprises performing a model competition process between the LIC model parameters and the NLIC model parameters.

5. The method of claim 4, wherein performing the model competition process comprises:
determining a template matching cost associated with applying LIC to a reference template block;
determining a template matching cost associated with applying NLIC to the reference template block; and
determining that the template matching cost associated with applying LIC is lower than the template matching cost associated with applying NLIC.

6. The method of claim 5, wherein decoding the current block using the inferred LIC model parameters or the inferred NLIC model parameters and the motion information of the second block further comprises:
determining a template matching cost associated with not applying LIC to the reference template block; and
determining that the template matching cost associated with applying LIC to the reference template block is less than the template matching cost associated with not applying LIC to the reference template block.

7. The method of claim 1, wherein the current block is a first current block, the method further comprising:
determining to decode a second current block of the video data using motion information of a third block of the video data;
determining a value of a LIC flag of the third block, the value of the LIC flag of the third block indicative of LIC being applied to the third block;
determining that LIC model parameters of the third block are trivial;
setting, based on the LIC model parameters of the third block being trivial, a LIC flag of the second current block to a value indicative of LIC not being applied to the second current block; and
decoding the second current block using the motion information of the third block without applying LIC.

8. The method of claim 1, further comprising storing the LIC model parameters or NLIC model parameters in memory for use with subsequent blocks of the video data.

9. The method of claim 1, the method further comprising:
determining that at least one partition of a geometric mode (GEO) block is inter predicted; and
based on at least one partition of the GEO block being inter predicted, storing a LIC flag value and LIC model parameters of one of the at least one partition of the GEO block in memory.

10. The method of claim 1, wherein the current block is a first current block, the method further comprising:
determining LIC model parameters of a third block;
determining an inverse of the LIC parameters;
applying the inverse of the LIC parameters to a template of second current block; and
decoding the second current block based on the applying the inverse of the LIC parameters to the template of the second current block.

11. A device for decoding video data, the device comprising:
one or more memories configured to store the video data; and
one or more processors operatively coupled to the one or more memories, the one or more processors configured to:
determine to decode a current block of the video data using motion information of a second block of the video data;
determine a value of a local illumination compensation (LIC) flag or a non-local illumination compensation (NLIC) flag of the second block, the value of the LIC flag or the NLIC flag of the second block indicative of LIC or NLIC being applied to the second block;
determine, based on the value of the LIC flag of the NLIC flag, to apply LIC or NLIC to the current block;
infer LIC model parameters or NLIC model parameters of the current block to be equal to LIC model parameters or NLIC model parameters of the second block; and
decode the current block including using the inferred LIC model parameters or the inferred NLIC model parameters and the motion information of the second block.

12. The device of claim 11, wherein as part of decoding the current block, the one or more processors are configured to use the motion information of the second block for one of an inter prediction mode, an intra block copy mode, an intra template matching mode, or a geometric mode.

13. The device of claim 11, wherein the second block is a neighboring block, a non-adjacent block, or a temporal block in a spatio-temporal causal neighborhood, of the current block.

14. The device of claim 11, wherein as part of decoding the current block using the inferred LIC model parameters or the inferred NLIC model parameters and the motion information of the second block, the one or more processors are configured to perform a model competition process between LIC model parameters and NLIC model parameters.

15. The device of claim 14, wherein as part of performing the model competition process, the one or more processors are configured to:
determine a template matching cost associated with applying LIC to a reference template block;
determine a template matching cost associated with applying NLIC to the reference template block; and
determine that the template matching cost associated with applying LIC is lower than the template matching cost associated with applying NLIC.

16. The device of claim 15, wherein as part of decoding the current block using the inferred LIC model parameters or the inferred NLIC model parameters and the motion information of the second block, the one or more processors are further configured to:
determine a template matching cost associated with not applying LIC to the reference template block; and
determine that the template matching cost associated with applying LIC to the reference template block is less than the template matching cost associated with not applying LIC to the reference template block.

17. The device of claim 11, wherein the current block is a first current block, and wherein the one or more processors are further configured to:
determine to decode a second current block of the video data using motion information of a third block of the video data;
determine a value of a LIC flag of the third block, the value of the LIC flag of the third block indicative of LIC being applied to the third block;
determine that LIC model parameters of the third block are trivial;
set, based on the LIC model parameters of the third block being trivial, a LIC flag of the second current block to a value indicative of LIC not being applied to the second current block; and
decode the second current block using the motion information of the third block without applying LIC.

18. The device of claim 11, wherein the one or more processors are further configured to store the LIC model parameters or NLIC model parameters in the one or more memories for use with subsequent blocks of the video data.

19. The device of claim 11, wherein the one or more processors are further configured to:
determine that at least one partition of a geometric mode (GEO) block is inter predicted; and
store, based on at least one partition of the GEO block being inter predicted, a LIC flag value and LIC parameters of one of the at least one partition of the GEO block in the one or more memories.

20. The device of claim 11, wherein the current block is a first current block, and wherein the one or more processors are further configured to:
determine LIC parameters of a third block;
determine an inverse of the LIC parameters;
apply the inverse of the LIC parameters to a template of second current block; and
decode the second current block based on the applying the inverse of the LIC parameters to the template of the second current block.

21. The device of claim 11, further comprising a display configured to display decoded video data.

22. A method of encoding video data, the method comprising:
encoding a second block of the video data including applying local illumination compensation (LIC) or non-local illumination compensation (NLIC) using a plurality of LIC model parameters or a plurality of NLIC model parameters;
signaling a LIC flag or an NLIC flag, a value of the LIC flag or the NLIC flag being indicative of LIC or NLIC being applied to the second block;
determining to encode a current block of the video data using motion information of the second block; and
encoding the current block using the motion information of the second block and the plurality of LIC parameters or the plurality of NLIC parameters.

23. The method of claim 22, wherein encoding the current block comprises using the motion information of the second block for one of an inter prediction mode, an intra block copy mode, an intra template matching mode, or a geometric mode.

24. The method of claim 22, wherein the second block is a neighboring block, a non-adjacent block, or a temporal block in a spatio-temporal causal neighborhood, of the current block.

25. The method of claim 22, wherein the current block is a first current block, the method further comprising:
determining LIC parameters of a third block;
determining an inverse of the LIC parameters;
applying the inverse of the LIC parameters to a template of second current block; and
encoding the second current block based on the applying the inverse of the LIC parameters to the template of the second current block.

26. A device for encoding video data, the device comprising:
one or more memories configured to store the video data; and
one or more processors operatively coupled to the one or more memories, the one or more processors configured to:
encode a second block of the video data including applying local illumination compensation (LIC) or non-local illumination compensation (NLIC) using a plurality of LIC parameters or a plurality of NLIC parameters;
signal a LIC flag or an NLIC flag, a value of the LIC flag or the NLIC flag being indicative of LIC or NLIC being applied to the second block;
determine to encode a current block of the video data using motion information of the second block; and
encode the current block using the motion information of the second block and the plurality of LIC parameters or the plurality of NLIC parameters.

27. The device of claim 26, wherein as part of encoding the current block, the one or more processors are configured to use the motion information of the second block for one of an inter prediction mode, an intra block copy mode, an intra template matching mode, or a geometric mode.

28. The device of claim 26, wherein the second block is a neighboring block, a non-adjacent block, or a temporal block in a spatio-temporal causal neighborhood, of the current block.

29. The device of claim 26, wherein the current block is a first current block, and wherein the one or more processors are configured to:
determine LIC parameters of a third block;
determine an inverse of the LIC parameters;
apply the inverse of the LIC parameters to a template of second current block; and
encode the second current block based on the applying the inverse of the LIC parameters to the template of the second current block.

30. The device of claim 26, further comprising a camera configured to capture the video data.
